(19) United States
(12) Patent Application Publication
(10) Pub. No.: US 2024/0239442 A1
(43) Pub. Date: Jul. 18, 2024

(54) TRANSMISSION SYSTEM FOR A VEHICLE, PREFERABLY A BICYCLE

(71) Applicant: CLASSIFIED CYCLING BV, Antwerpen (BE)

(72) Inventor: Roëll Marie VAN DRUTEN, Eindhoven (NL)

(21) Appl. No.: 18/564,309

(22) PCT Filed: Apr. 25, 2022
(86) PCT No.: PCT/EP2022/060915

§ 371 Date: Nov. 27, 2023

(30) Foreign Application Priority Data
May 28, 2021 (NL) 2028336
Jul. 9, 2021 (NL) 2028685
Jul. 9, 2021 (NL) 2028686
Jul. 26, 2021 (NL) 2028836
Dec. 23, 2021 (NL) 2030258
Dec. 23, 2021 (NL) 2030261
Mar. 1, 2022 (NL) 2031121
Mar. 1, 2022 (NL) 2031123

(51) Int. Cl. B62M 11/14; B62M 6/55; B62M 11/16

(52) U.S. Cl. CPC B62M 11/145; B62M 11/16; B62M 6/55

(57) ABSTRACT

Disclosed is a transmission system for a vehicle, particularly for a bicycle. The system comprises an input and an output, and a first transmission and a second transmission between the input and the output, wherein the first transmission and the second transmission are connected in series. The first transmission is selectively operable according to a first transmission ratio or a second transmission ratio, and has a first load-shifting clutch for switching the first transmission from the first transmission ratio to the second transmission ratio and/or vice versa. The second transmission is selectively operable according to a third transmission ratio or a fourth transmission ratio, and has a second load-shifting clutch for switching the second transmission from the third transmission ratio to the fourth transmission ratio and/or vice versa.

### FIELD

The invention relates to a transmission system for a vehicle, particularly a human powered vehicle, such as a bicycle, e.g. a two-wheeled bicycle.

### BACKGROUND TO THE INVENTION

Transmission systems for bicycles are known. In bicycles, especially racing bicycles, the transmission system traditionally includes a front derailleur and a rear derailleur for shifting gears of the transmission system. An alternative to derailleurs is formed by gear hubs, where shifting of gears is accommodated by a gear shifting mechanism inside the, generally rear, wheel hub. A hybrid form is known where a gear hub torque transmission having at least two selectable gear ratios is coupled between the rear wheel hub and the rear sprocket. Herein the rear sprocket can include a plurality of gear wheels, selectable through a rear derailleur. Here the gear hub can take the place of a front derailleur.

Such gear hub gear shifting mechanisms can include one or more planetary gear sets. The planetary gear includes at least three rotational members, such as a sun gear, a planet carrier and a ring gear. A clutch system can be used for selectively coupling two of the rotational members, e.g. the planet carrier and the ring gear. When coupled, the hub gear shifting mechanism operates according to a first gear ratio. When decoupled, the hub gear shifting mechanism operates according to a second gear ratio.

Also gear hub shifting mechanisms are known wherein mechanisms are included in the gear hub for providing a plurality of different transmission ratios, such as five, seven or fourteen different gear ratios.

Many of these systems have in common that up- and downshifting is not always possible, depending on the riders pedal force. In some systems, it is required that the rider stops pedaling, or at least stops providing torque load to the system to allow up-shifting and/or down-shifting.

### SUMMARY

It is an object to provide a transmission system, such as for a, e.g. two wheeled, bicycle. Alternatively, or additionally, it is an object to enable, preferably electronically actuated, shifting of gears, wherein up- and downshifting should always be possible, not depending on the riders pedal force and/or electromotor torque.

According to an aspect is provided a transmission system for a vehicle, particularly a human powered vehicle such as bicycle, comprising an input and an output, wherein the input is arranged to be connected to a power source, such as a crank and/or an electric motor and/or a user input, and the output is arranged to be connected to a load, such as a driven wheel. The transmission system comprises a first transmission and a second transmission between the input and the output, wherein the first transmission and the second transmission are connected in series. The first transmission is selectively operable according to a first transmission ratio or a second transmission ratio, and has a first clutch for switching the first transmission from the first transmission ratio to the second transmission ratio and/or vice versa. The second transmission is selectively operable according to a third transmission ratio or a fourth transmission ratio, and has a second clutch for switching the second transmission from the third transmission ratio to the fourth transmission ratio and/or vice versa. The transmission system can provide for four different system transmission ratios between the input and the output. The term “system transmission ratio” herein is used to indicate the effective transmission ratio between the input and the output of the transmission system. In other words, the transmission system can act as a four-speed transmission. The first and second clutches can be used for shifting between the different system transmission ratios.

The first transmission may have a first input and a first output, wherein the first input can be connected to the system input. The second transmission may have a second input and a second output, wherein the second output can be connected to the system output. The first output may be connected to the second input. Also the first output and the second input may be connected to an intermediate member, such as an intermediate shaft, for transferring torque from the first output to the second input.

Different combinations of one of the first and second transmission ratios with one of the third and fourth transmission ratios of the serially arranged transmissions enable the transmission system to operate according to various distinct system transmission ratios between the input and output of the system.

The transmission system can for example operate according to a first system transmission ratio, when the first transmission operates according to the first transmission ratio and the second transmission operates according to the third transmission ratio. Similarly, the transmission system can for example operate according to a second system transmission ratio, when the first transmission operates according to the second transmission ratio and the second transmission operates according to the third transmission ratio. Also, the transmission system can for example operate according to a third system transmission ratio, when the first transmission operates according to the first transmission ratio and the second transmission operates according to the fourth transmission ratio. The transmission system can for example operate according to a fourth system transmission ratio, when the first transmission operates according to the second transmission ratio and the second transmission operates according to the fourth transmission ratio.

Optionally, each of the first and second clutch is a form-closed clutch arranged to transfer torque in at least one rotational direction.

Optionally, each of the first and second clutch is a load-shifting clutch arranged for being coupled and/or decoupled under load. It may be preferred to couple and/or decouple the clutches of the transmission system under load, to switch between transmission ratios while transmitting torque through the transmission system.

Optionally, the first transmission is arranged to operate according to the first transmission ratio when the first clutch is in a first state, and to operate according to the second transmission ratio when the first clutch is in a second state. The first clutch for instance has a coupled state in which a first clutch input and a first clutch output of the first clutch are coupled for transferring torque from the first clutch input to the first clutch output. The first clutch may also have a decoupled state in which the first clutch input and the first clutch output are decoupled. The first state of the first clutch may correspond to the coupled state, and the second state of the first clutch may correspond to the decoupled state, or vice versa.

Optionally, the second transmission is arranged to operate according to the third transmission ratio when the second clutch is in a first state, and to operate according to the fourth transmission ratio when the second clutch is in a second state. The second clutch for instance has a coupled state in which a second clutch input and a second clutch output of the second clutch are coupled for transferring torque from the second clutch input to the second clutch output. The second clutch may also have a decoupled state in which the second clutch input and the second clutch output are decoupled. The first state of the second clutch may correspond to the coupled state, and the second state of the second clutch may correspond to the decoupled state, or vice versa.

The first clutch and the second clutch are optionally, at least substantially, identical.

Optionally, the first transmission includes a first transmission path and a second transmission path parallel to the first transmission path, wherein at least one of the first and second transmission paths includes the first clutch. Hence, torque can be selectively transmitted through either the first or the second transmission path, using the first clutch. For example, in a coupled state of the first clutch, torque can be transmitted through the transmission path which include the first clutch, e.g. the first transmission path. In an uncoupled state of the first clutch, no torque can be transmitted through the transmission path which includes the first clutch. Instead, torque can for instance be transmitted through the other, parallel, transmission path, e.g. the second transmission path.

The first transmission path may for example include a first gearing for providing the first transmission ratio; the second transmission path a second gearing for providing the second transmission ratio; the third transmission path a third gearing for providing the third transmission ratio; the fourth transmission path a fourth gearing for providing the fourth transmission ratio, etc. Each of said gearings may for example include meshing gears, e.g. a meshing primary and secondary gear pair, and/or belt-driven wheels, e.g. a primary and secondary gear pair drivingly coupled via an endless drive member such as a belt or chain.

Optionally, the first clutch is arranged in the second transmission path, wherein the first transmission path includes a first freewheel clutch. The first freewheel clutch is optionally serially connected between the first transmission input and the first gearing. The first freewheel clutch may alternatively be serially connected between the first gearing and the first transmission output.

Optionally, the second transmission path includes a second freewheel clutch.

Optionally, an output of the second freewheel is connected to an input of the first clutch. Hence, freewheeling between the transmission input and transmission output can be allowed also when the first clutch is in the coupled state.

Optionally, the second freewheel clutch is serially connected between the second gearing and the first clutch.

Optionally, the first clutch is serially connected between the second freewheel clutch and the second gearing.

Optionally, the second gearing is serially connected between the first clutch and the second freewheel clutch.

Optionally, the second transmission includes a third transmission path and a fourth transmission path parallel to the third transmission path, at least one of the third and fourth transmission paths including the second clutch. For example, in a coupled state of the first clutch, torque can be transmitted through the transmission path which include the first clutch, e.g. the third transmission path. In an uncoupled state of the first clutch, no torque can be transmitted through the transmission path which includes the first clutch. Instead, torque can for instance be transmitted through the other, parallel, transmission path, e.g. the fourth transmission path.

Optionally, the second clutch is arranged in the fourth transmission path, wherein the third transmission path includes a third freewheel clutch. The third freewheel clutch is optionally serially connected between the second transmission input and the third gearing. The third freewheel clutch may alternatively be serially connected between the third gearing and the second transmission output.

Optionally, the fourth transmission path includes a fourth freewheel clutch.

Optionally, an output of the fourth freewheel is connected to an input of the second clutch.

Hence, the second freewheel clutch may be serially connected to the first clutch at an input side of the first clutch and/or the fourth freewheel clutch may be serially connected to the second clutch at an input side of the second clutch.

Optionally, the fourth freewheel clutch is serially connected between the fourth gearing and the second clutch.

Optionally, the second clutch is serially connected between the fourth freewheel clutch and the fourth gearing.

Optionally, the fourth gearing is serially connected between the second clutch and the fourth freewheel clutch.

Optionally, in a particular compact setup, the second freewheel clutch is serially connected between the second gearing and the first clutch, and the fourth gearing is serially connected between the second clutch and the fourth freewheel clutch. Hence, an output of the first transmission may be formed by an output of the first clutch, and an input of the second transmission may be formed by an input the second clutch. The first clutch output and the second clutch input may for example be coupled to each other or integrated.

Optionally, at least one of the first transmission and the second transmission includes a planetary gear set.

Optionally, at least one of the first transmission ratio, the second transmission ratio, the third transmission ratio and the fourth transmission ratio is a 1:1 transmission ratio. Optionally, the smallest transmission ratio of the first, second, third and fourth transmission is a 1:1 transmission ratio. Optionally, the smallest system transmission ratio of the transmission system is a 1:1 transmission ratio. For street or racing bicycles a 1:1 system transmission ratio as smallest system transmission ratio can be desirable. For mountain bikes or all terrain bikes a smallest system transmission ratio of smaller than 1:1 may be desirable.

Optionally, the first transmission ratio or the second transmission ratio is equal or inverse to the third transmission ratio or the fourth transmission ratio.

Optionally, the first transmission ratio or the second transmission ratio equals 1, and the third transmission ratio or the fourth transmission ratio also equals 1.

Optionally, the third transmission ratio equals the lowest desired system transmission ratio by the first transmission ratio. For example, a product of the first transmission ratio and the third transmission ratio provides the lowest system transmission ratio.

Optionally, when a ratio of the second transmission ratio and the first transmission ratio is equal to U, a ratio of the fourth transmission ratio and the third transmission ratio is, e.g. within 5%, equal to U². In other words, the ratio of the fourth transmission ratio and the third transmission ratio is, e.g. within 5%, equal to the square of the ratio of the second transmission ratio and the first transmission ratio. For example, when the second transmission ratio divided by the first transmission ratio is equal to U, a the fourth transmission ratio divided by the third transmission ratio is, e.g. within 5%, equal to U².

Optionally, when a ratio of the second transmission ratio and the first transmission ratio is, e.g. within 5%, equal to U, a product of the first transmission ratio and the fourth transmission ratio is, e.g. within 5%, equal to U². In other words, the product of the first transmission ratio and the fourth transmission ratio is equal to the ratio of the second transmission ratio and the first transmission ratio. For example, when the second transmission ratio divided by the first transmission ratio is, e.g. within 5%, equal to U, the first transmission ratio times the fourth transmission ratio is, e.g. within 5%, equal to U².

Optionally, a ratio of the second transmission ratio and the first transmission ratio equals, e.g. within 5%, to a product of the second transmission ratio and the third transmission ratio.

Optionally, a ratio of the second transmission ratio and the first transmission ratio is between 1.1 and 1.3, preferably about 1.2. The ratio of the second transmission ratio and the first transmission ratio is for example 1.20 or 1.24. The ratio of the fourth transmission ratio and the third transmission ratio is for example 1.44 or 1.54. For example, the first transmission ratio is 1, the second transmission ratio is 1.2, the third transmission ratio is 1, and the fourth transmission ratio is 1.44.

Optionally, the second or fourth transmission ratio is a speed up transmission ratio. It will be appreciated that a transmission ratio of a transmission is defined as an output speed of an output of the transmission divided by an input speed of an input of the transmission. A speed up transmission ratio thus corresponds to a transmission in which the output speed of the transmission is higher than an input speed of the transmission. The speed-up transmission ratio is thus larger than one. Optionally, the first, second, third or fourth transmission ratio is a reduction transmission ratio. A reduction transmission ratio thus corresponds to a transmission in which the output speed of the transmission is lower than an input speed of the transmission. A reduction transmission ratio is smaller than one.

Optionally, the second transmission ratio is larger than the first transmission ratio. The first clutch may particularly be in the transmission path of the first transmission having the largest transmission ratio.

Optionally, at least one of the first transmission ratio and the second transmission ratio is a speed-down transmission ratio, and at least one of the third transmission ratio and the fourth transmission ratio is a speed-up transmission ratio. Alternatively, at least one of the first transmission ratio and the second transmission ratio is a speed-up transmission ratio, and at least one of the third transmission ratio and the fourth transmission ratio is a speed-down transmission ratio.

Optionally, wherein the second transmission ratio is smaller than the first transmission ratio.

Optionally, when the first transmission ratio or the second transmission ratio is, e.g. within 5%, equal to U, the third transmission ratio or the fourth transmission ratio is, e.g. within 5%, equal to U⁻². In other words, the third transmission ratio or the fourth transmission ratio is, e.g. within 5%, equal to the squared inverse of the first transmission ratio or the squared inverse of the second transmission ratio.

Optionally, when the first transmission ratio or the second transmission ratio is, e.g. within 5%, equal to U, the third transmission ratio or the fourth transmission ratio is, e.g. within 5%, equal to U^{-1/2}. In other words, the third transmission ratio or the fourth transmission ratio is, e.g. within 5%, equal to the square root of the inverse of the first transmission ratio or the square root of the inversed second transmission ratio.

Optionally, the transmission system comprises a third transmission connected in series with the first and second transmissions between the input and the output, the third transmission having a third clutch, and the third transmission being operable according to a fifth transmission ratio and a sixth transmission ratio. Hence, the transmission system can provide for eight system transmission ratios between the input and the output. The third clutch is optionally a form-closed clutch arranged to transfer torque in at least one rotational direction. The third clutch may be arranged for being coupled and/or decoupled under load. It will be appreciated that the third transmission may be similar to the first transmission and/or the second transmission as described herein. Hence, any features described herein in view of the first and/or second transmission apply equally to the third transmission.

Optionally, the third transmission is arranged to operate according to the fifth transmission ratio when the third clutch is in a first state, and to operate according to the sixth transmission ratio when the third clutch is in a second state. The third clutch for instance has a coupled state in which a third clutch input and a third clutch output of the third clutch are coupled for transferring torque from the third clutch input to the third clutch output. The third clutch may also have a decoupled state in which the third clutch input and the third clutch output are decoupled. The first state of the third clutch may correspond to the coupled state, and the second state of the third clutch may correspond to the decoupled state, or vice versa.

Optionally, when a ratio of the second transmission ratio and the first transmission ratio is equal to U, a ratio of the fourth transmission ratio and the third transmission ratio is e.g., e.g. within 5%, equal to U², and a ratio of the sixth transmission ratio and the fifth transmission ratio is, e.g. within 5%, equal to U⁴.

Optionally, the transmission system comprises a bypass transmission path between the input and the output parallel to the first and/or the second transmission, said bypass transmission path including a bypass transmission clutch, such as a freewheel clutch. Hence, the bypass transmission path can provide an additional transmission ratio between the system input and the system output.

Optionally, the transmission system comprises a bypass transmission path between the input and the output parallel to the first and/or the second and/or the third transmission, said bypass transmission path including a bypass clutch, such as a freewheel clutch.

Optionally, a bypass clutch actuator is provided for selectively actuating the bypass clutch between a coupled state in which the bypass clutch couples a bypass clutch input with a bypass clutch output for transferring torque and a decoupled state in which the bypass clutch input and bypass clutch are decoupled.

Optionally, the transmission system comprises an intermediate shaft, wherein the first transmission is operable between the input and the intermediate shaft, and the second transmission is operable between the intermediate shaft and the output. The first output of the first transmission and the second input of the second transmission may be connected or connectable to the intermediate shaft.

Optionally, the transmission system comprises an input shaft associated with the input, and an output shaft associated with the output, wherein the input shaft is connectable to the output shaft via the intermediate shaft.

Optionally, the output shaft extends coaxially to the input shaft. Hence, the input and output shafts can be substantially aligned.

Optionally, the output shaft is offset from the input shaft.

Optionally, each of the clutches, e.g. the first, second and third clutch, are a form-closed clutches arranged to transfer torque in at least one rotational direction.

Optionally, each of the clutches is a load-shifting clutch arranged for being coupled and/or decoupled under load.

Optionally, each load-shifting clutch has a clutch input, and a clutch output, each clutch including:
a first unit connectable to the clutch input or clutch output, including at least one first abutment surface;
a second unit connectable to the clutch output or clutch input, respectively, including at least one second abutment surface arranged for selectively engaging the first abutment surface, the first and second abutment surfaces being adapted to each other so as to allow disengaging under load, preferably in two directions;
a third unit including at least one retaining member, the third unit being arranged for selectively being in a first mode or a second mode relative to the second unit, wherein the at least one retaining member in the first mode locks the at least one second abutment surface for rotationally coupling the second unit to the first unit, e.g. in two directions, and in the second mode releases the at least one second abutment surface for decoupling the second unit from the first unit. The transmission system including such load-shifting clutch (or clutches) can be manufactured in a small form-factor suitable for integration in a two-wheeled bicycle.

Optionally, each clutch includes an actuator for moving the third unit from a first position to a second position or from a second position to a first position relative to the second rotatable unit.

Optionally, the third unit includes at least one actuation member arranged for moving the third unit from a first position to a second position or from a second position to a first position relative to the second rotatable unit.

Optionally, the clutch includes a first rotatable unit connectable to the input; a second rotatable unit connectable to the output; a third rotatable unit arranged for co-rotating with the second rotatable unit, the third rotatable unit being arranged for selectively being in a first rotational position or a second rotational position relative to the second rotatable unit, wherein the system is arranged for selectively in the first rotational position rotationally coupling the second rotatable unit to the first rotatable unit, and in the second rotational position decoupling the second rotatable unit from the first rotatable unit; wherein the system is arranged for temporarily changing rotation speed of the third rotatable unit relative to the second rotatable unit for rotating from the first position to the second position, or from the second position to the first position.

Optionally, each clutch further comprises a fourth unit including a selector, the selector being arranged for selectively being in a gripping or non-gripping mode; the selector in the gripping mode being arranged for gripping the at least one actuation member for rotating the third rotatable unit from the first position to the second position or from the second position to the first position relative to the second rotatable unit; the selector in the non-gripping mode being arranged for not engaging the at least one actuation member.

Optionally, the first unit of the first load-shifting clutch, and the first unit of the second load-shifting clutch are coupled or integrated together.

Optionally, the second unit of the second load-shifting clutch is bearing supported by the first unit of the first load-shifting clutch.

The clutches described herein may for example be load-shifting clutches as described in WO2018/199757A2, WO2020/085911A2, or WO2021/080431A1 which are hereby incorporated by reference in their entirety.

Optionally, the transmission system comprises a control unit configured to receive a first shift signal and a second shift signal, and configured to control the first clutch and/or the second clutch (and/or the third clutch) for selectively coupling or decoupling in response to receiving the first and/or second shift signal. The controller allows for simplified operation of the transmission system. By having the first and second transmissions connected in series, there is no risk of lock-up of the transmission system when actuating the first and second clutches independently and/or simultaneously.

Optionally, the first shift signal is an upshift signal and the second shift signal is a downshift signal, and the controller is configured to selectively control the first and/or second (and/or third) clutch for selecting the next higher system transmission ratio in response to receiving the upshift signal, and for selecting the next lower system transmission ratio in response to receiving the downshift signal. Hence, the rider only needs to provide the upshift signal or the downshift signal, e.g. by means of one or more controls, levers, switches or the like. Preferably, the first and second shift signals are electronic signals. The first and/or second and/or third clutch can include a first and/or second and/or third actuator, respectively, for electrically actuating the respective clutch to couple or decouple. The controller then controls the first and second (and third) actuators in response to the upshift or downshift signal provided by the rider. Depending on the system transmission ratio used at that point in time, the next higher system transmission ratio can be achieved by actuating the first actuator and/or the second actuator (and/or third actuator). The controller is configured to select and actuate the appropriate actuator. Thus, shifting is simplified for the user.

Optionally, the first shift signal is an upshift signal and the second shift signal is a downshift signal, and the controller is configured to selectively control the first and/or second clutch (and/or third clutch) for selecting the second next, third next, fourth next higher or lower system transmission ratio in response to receiving a bail-out signal, the bail-out signal e.g. comprising the upshift signal and downshift signal at the same time, or within a specified time-interval, typically smaller than 1 s.

Optionally, the first and second shift signals are wireless signals, and wherein the control unit is arranged to receive the wireless shift signals.

Optionally, the system comprises one or more actuators, particularly one or more electric actuators, arranged for actuating the clutches.

Optionally, the one or more actuators are operatively connected to the control unit.

Optionally, the control unit and the one or more actuators are arranged to wirelessly communicate.

Optionally, the system comprises a torque sensor for measuring an input torque at the input, wherein the torque sensor is operatively connected to the control unit. The torque sensor may for example be arranged to measure a torque at a crank and/or at a crankshaft.

Optionally, the torque sensor is integrated in the transmission system.

Optionally, the control unit and the torque sensor are arranged to wirelessly communicate.

Optionally, the torque sensor is arranged to be powered by a rotary motion of a crank and/or crankshaft about a crank axis.

Optionally, the torque sensor is arranged to be wirelessly powered.

Optionally, the system comprises an electric motor, for propelling, or assist propelling, of the vehicle, wherein the electric motor is connected to the input, to the output, or to an intermediate member.

Optionally, the system comprises a battery arranged for powering the electric motor, and further arrange for powering the one or more actuators and/or sensors.

Optionally, a continuously variable transmission is arranged between the first transmission and the second transmission.

Optionally, the system comprises a continuously variable transmission arranged between a system input and the first transmission or between the second transmission and a system output.

Optionally, the continuously variable transmission is of a ratcheting type, e.g. using freewheel or one-way drive modules.

According to a further aspect is provided a crank assembly for a bicycle, comprising a crank coupled to an input shaft and a chain wheel coupled to an output shaft for meshing with an endless drive member, and a transmission system as described herein, wherein the transmission system is arranged between the crank and the chain wheel.

Optionally, the input shaft and the output shaft are rotatable around a common drive axis, and wherein the crank assembly comprises an electric motor connected to the input shaft or the output shaft, wherein the electric motor has a rotatable output member that is rotatable about an electric motor output axis which extends transverse to the drive axis. Hence, a particular compact setup can be obtained.

Optionally, the electric motor is angularly spaced from the intermediate shaft.

According to a further aspect is provided a bicycle comprising a transmission system as described herein, or a crank assembly as described herein.

Optionally, the bicycle comprises a torque transfer system having a torque transfer member, such as a chain or belt or shaft, wherein a crank drives an input of the torque transfer system, and wherein an output of the torque transfer system drives a driven wheel of the bicycle, wherein the transmission system is arranged between the crank and the input of the torque transfer system. The first transmission and the second transmission (and the third transmission) may be housed in a common housing placed at the location of the crank.

Optionally, the bicycle comprises a torque transfer system having a torque transfer member, such as a chain or belt or shaft wherein a crank drives an input of the torque transfer system, and wherein an output of the torque transfer system drives a driven wheel of the bicycle, wherein the transmission system is arranged between the output of the torque transfer system and a wheel hub of the driven wheel. The first transmission and the second transmission (and the third transmission) may be housed in a common housing at the wheel axle.

Optionally, the bicycle comprises a torque transfer system having a torque transfer member, such as a chain or belt or shaft wherein a crank drives an input of the torque transfer system, and wherein an output of the torque transfer system drives a driven wheel of the bicycle, wherein the first transmission of the transmission system is arranged between the crank and the input of the torque transfer system, and wherein the second transmission of the transmission system is arranged between the output of the torque transfer system and a wheel hub of the driven wheel. The first transmission may be housed at the location of the crank, and the second transmission may be housed at the wheel axle.

Optionally, the bicycle comprises a torque transfer system having a torque transfer member, such as a chain or belt or shaft wherein a crank drives an input of the torque transfer system, and wherein an output of the torque transfer system drives a driven wheel of the bicycle, wherein the first and second transmission of the transmission system are arranged between the crank and the input of the torque transfer system, and wherein the third transmission of the transmission system is arranged between the output of the torque transfer system and a wheel hub of the driven wheel. The first transmission and the second transmission may be housed in a common housing placed at the location of the crank, and the third transmission may be housed at the wheel axle.

Optionally, the bicycle comprises a continuously variable transmission (CVT) arranged between the first transmission and the second transmission. Optionally, the bicycle comprises a CVT arranged between the second transmission and the third transmission. Optionally, the bicycle comprises a CVT arranged between a system input and the first transmission or between the second transmission and a system output. Optionally, the bicycle comprises a CVT arranged between a system input and the first transmission or between the third transmission and a system output. The CVT can be a ratcheting type of CVT, e.g. using freewheel or one-way drive modules. The CVT can be used for increasing the number of system transmission ratios. The CVT can be controlled to selectively operate at one of two or three (or more) distinct transmission ratios. The CVT can be controlled to operate at a first CVT transmission ratio and a second CVT transmission ratio. A ratio of the second CVT transmission ratio and the first CVT transmission ratio can be chosen to be, e.g. approximately, half of the ratio of the second transmission ratio and the first transmission ratio. The CVT can be controlled to operate at a first CVT transmission ratio, a second CVT transmission ratio and a third CVT transmission ratio. A ratio of the second CVT transmission ratio and the first CVT transmission ratio can be chosen to be, e.g. approximately, one third of the ratio of the second transmission ratio and the first transmission ratio, and a ratio of the third CVT transmission ratio and the first CVT transmission ratio can be chosen to be, e.g. approximately, two third of the ratio of the second transmission ratio and the first transmission ratio.

The CVT may for example comprise a first drive element that is rotatable about a first axis; a second drive element that is rotatable about a second axis parallel to the first axis, wherein the first drive element and the second drive element are movable relative to each other in a direction transverse to the first and second axis; and first coupling elements provided at a constant first radius from the first axis and at a variable second radius from the second axis, for transferring torque between the first drive element and the second drive element.

The CVT may be configured to be operable according to any transmission ratio within a continuous range of CVT transmission ratios. The CVT may particularly be configured to be operable according to a predetermined finite set of transmission ratios within the continuous range of CVT transmission ratios. Hence, the CVT may be used as a discrete transmission, wherein the discrete transmission ratio steps are (pre)programmably adaptable.

A transmission ratio of a transmission as described herein, is particularly an output speed of the transmission divided by an input speed of the transmission.

According to an aspect is provided a gearless transmission unit such as for a bicycle, providing at least two discrete selectable transmission ratios, wherein a first of the at least two transmission ratios is provided by a first endless drive member, and wherein a second of the at least two transmission ratios is provided by a second endless drive member.

Optionally, the first and second endless drive members are placed in parallel between an input and an output of the gearless transmission unit, and the gearless transmission unit includes a selector for selecting power transmission via the first or the second endless drive member.

Optionally, the gearless transmission unit includes a clutch for selecting power transmission via the first endless drive member or the second endless drive member.

Optionally, the gearless transmission unit further includes a third endless drive member and a fourth endless drive member, wherein the third and fourth endless drive members are placed in parallel between an output of the first and second endless drive members and an output of the gearless transmission unit, and the gearless transmission unit includes a selector for selecting power transmission via the third or the fourth endless drive member.

Optionally, the gearless transmission unit includes a clutch for selecting power transmission via the third endless drive member or the fourth endless drive member.

Optionally, the clutch is arranged to be coupled and/or decoupled under load. The clutch is for example a load-shifting clutch.

Optionally, at least one of the first, second, third and fourth endless drive members is non-lubricated. In particular, each endless drive member of the gearless transmission unit may be non-lubricated. Hence, no lubrication fluid is provided on at least one of the first endless drive member, the second endless drive member, the third endless drive member and the fourth endless drive member, particularly on all four of said endless drive members. A dry drive system can hence be obtained.

Optionally, the at least one of the first, second, third and fourth endless drive members comprises, e.g. is, a dry belt or a dry chain.

Optionally, at least one of the first, second, third and fourth endless drive members comprises a lubricated chain. In particular, and as alternative to a dry drive system, each endless drive member of the gearless transmission unit may be lubricated, e.g. with a lubrication fluid such as an oil.

Optionally, the gearless transmission unit includes a continuously variable transmission.

According to an aspect, each of the transmission ratios provided by the transmission system as described herein is oil-free, preferably lubrication-free.

According to an aspect is provided a hub assembly for a bicycle including the gearless transmission unit.

According to an aspect is provided a crank assembly for a bicycle including the gearless transmission unit. According to an aspect is provided a bicycle including the gearless transmission unit.

According to an aspect is provided a distributed transmission system for a bicycle, comprising a crank transmission including the first transmission as described herein and a hub transmission comprising the second transmission as described herein. It will be appreciated that alternatively the crank transmission may including the second transmission as described herein and the hub transmission may comprise the first transmission as described herein.

It will be appreciated that any one or more of the above aspects, features and options can be combined. It will be appreciated that any one of the options described in view of one of the aspects can be applied equally to any of the other aspects. It will also be clear that all aspects, features and options described in view of the transmissions system apply equally to the bicycle. It will also be clear that all aspects, features and options described in view of the control device and control system apply equally to the transmission system, assembly, and bicycle.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic example of a transmission system;

FIGS. 2A-2C show schematics examples of transmission systems;

FIG. 3 shows a schematic layout of a transmission system.

FIGS. 4A-4B show a schematic example of a transmission system;

FIGS. 5A-5B show a schematic example of a transmission system;

FIGS. 6A-6B show a schematic example of a transmission system;

FIGS. 7A-7B show a schematic example of a transmission system;

FIG. 8 shows a schematic example of a transmission system;

FIG. 9A-9C show a schematic example of a transmission system;

FIG. 10 shows a schematic example of a transmission system;

FIGS. 11A-11B show a schematic example of a transmission system;

FIGS. 12A-12B show a schematic example of a transmission system;

FIGS. 13A-13B show a schematic example of a transmission system;

FIG. 14 shows a schematic layout of a transmission system;

FIGS. 15A-15B show schematic layouts of a transmission system;

FIGS. 16A-16B show schematic layouts of a transmission system;

FIGS. 17A-17B show schematic layouts of a transmission system;

FIGS. 18A-18B show schematic layouts of a transmission system;

FIGS. 19A-19B shows a schematic layout of a transmission system;

FIGS. 20A-20B show schematic examples of a transmission system;

FIGS. 21A-21B show schematic layouts of a transmission system;

FIG. 22 shows a schematic layout of a transmission system;

FIGS. 23A-23C show an example of a transmission system for a crank assembly;

FIG. 24 shows a schematic example of a transmission system;

FIG. 25 shows a schematic example of a transmission system;

FIG. 26 shows an example of a bicycle.

### DETAILED DESCRIPTION

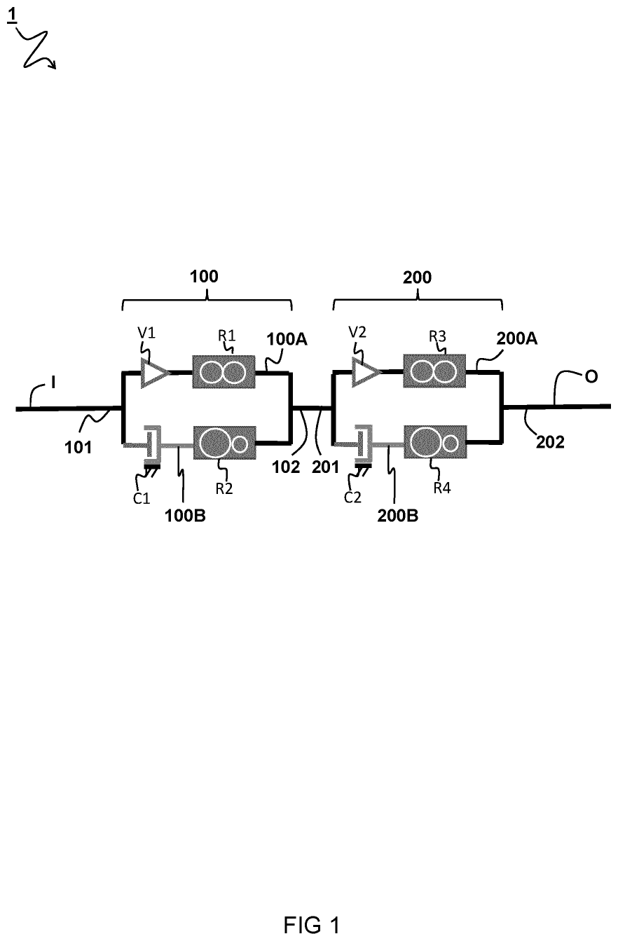

FIG. 1 shows an example of a transmission system 1, such as for a two wheeled bicycle. The transmission system 1 includes an input I and an output O. The input I can for example be connected to a crank of the bicycle. The output O can for example be connected to a front chain ring of the bicycle. Between the input I and the output O, the system includes a first transmission 100 and a second transmission 200. The first and second transmissions 100, 200 are connected to one another in series. A first input 101 of the first transmission 100 is connected to the system input I. A second output 202 of the second transmission 200 is connected to the system output O. A first output 102 of the first transmission 100 is connected to a second input 201 of the second transmission 200. It will be appreciated that the first output 102 and the second input 201 may be connected to each other via an intermediate member, such as an intermediate shaft.

The first transmission 100 is operable according to a first transmission ratio and a second transmission ratio. Similarly, the second transmission 200 is operable according to a third transmission ratio and a fourth transmission ratio. The first and second transmissions 100, 200 may include respective gearing, e.g. one or more gears, for providing a reduction or increase transmission ratio between the first input 101 and first output 102, and between the second input 201 and second output 202, respectively. The serial arrangement of the first and second transmissions 100, 200 can thus provide for four distinct system transmission ratios between the system input I and the system output O.

To shift between the first transmission ratio and the second transmission ratio, the first transmission 100 includes a first clutch, in this example a load-shifting clutch, C1. Similarly, the second transmission 100 includes a second clutch, in this example a load-shifting clutch, C2, for selectively shifting between the third transmission ratio and the fourth transmission ratio of the second transmission 200. The first load-shifting clutch C1 and the second load-shifting clutch C2 are thus serially arranged between the system input I and the system output O.

The first transmission 100 has two parallel transmission paths between the first input 101 and first output 102, namely a first transmission path 100A and a second transmission path 100B. At least one of the first and second transmission paths 100A, 100B includes the first load-shifting clutch C1. Also, at least one of the parallel transmission paths 100A, 100B includes a transmission gearing. In this example, the first transmission path 100A includes a first gearing R1 arranged for providing the first transmission ratio, and the second transmission path 100B includes a second gearing R2 for providing the second transmission ratio.

Similarly, the second transmission 200 has two parallel transmission paths between the second input 201 and the second output 202, namely a third transmission path 200A and a fourth transmission path 200B. at least one of the third and fourth transmission paths 200A, 200B includes the second load-shifting clutch C2. Also, at least one of the parallel transmission paths 200A, 200B of the second transmission 200 includes a transmission gearing. In this example, the third transmission path 200A includes a third gearing R3 arranged for providing the third transmission ratio, and the fourth transmission path 200B includes a gearing fourth R4 for providing the fourth transmission ratio.

The load-shifting clutches C1 and C2, can be used to select an appropriate transmission path between the system input I and system output O. More particular, the first load-shifting clutch C1 can be used to selectively switch between the first 100A and second 100B parallel transmission paths of the first transmission 100, and the second load-shifting clutch C2 can be used to selectively switch between the third 200A and fourth 200B parallel transmission paths of the second transmission 200. Hence, in this example, four different transmission paths can be obtained between the system input I and system output O, which can be selectively switched using the load-shifting clutches C1, C2.

The load-shifting clutches include at least two states, e.g. a coupled state and a decoupled state, wherein the coupled state couples the clutch input with the clutch output to transmit torque through the clutch, and the decoupled state decouples the clutch input from the clutch output to transmit no torque through the clutch. In the decoupled state, the load shifting clutches C1, C2 enable torque to be transmitted through different, parallel, transmission path.

In the coupled state of the first load-shifting clutch C1, torque can be transmitted through the second transmission path 100B from the system input I to the first output 102. In the decoupled state, torque can be transmitted through the first transmission path 100A from the system input I to the first output 102. Similarly, in the coupled state of the second load-shifting clutch C2, torque can be transmitted through the fourth transmission path 200B from the second input 201 to the system output O. In the decoupled state, torque can be transmitted through the third transmission path 200A from the first input 201 to the system output O.

In this example, the load-shifting clutches C1, C2 are provided in, respectively, the second transmission path 100B and the fourth transmission path 200B, but it will be appreciated that the first load-shifting clutches C1, C2 can also be provided in, respectively, the first transmission path 100A and the third transmission path 200A. The first load-shifting clutch C1 is here provided between the first input 101 and the second gearing R2, but the first load-shifting clutch C1 can also be provided between the second gearing R2 and the first output 102. Similarly, the second load-shifting clutch C2 is here provided between the second input 201 and the fourth gearing R4, but the second load-shifting clutch C2 can also be provided between the fourth gearing R4 and the second output 202.

Here, the first transmission path 100A includes a first freewheel clutch V1. The first freewheel clutch V1 can be overrun, e.g. when torque is transmitted through the second transmission path 100B, e.g. when the first output 102 rotates faster than the first input 101. Here, the third transmission path 200A includes a third freewheel clutch V2. The third freewheel clutch V2 can be overrun, e.g. when torque is transmitted through the fourth transmission path 200B, e.g. when the second output 202 rotates faster than the second input 201. The freewheel clutches V1, V2 are preferably low friction when overrun to reduce losses.

Here the freewheel clutches V1, V2 are connected to an input of respective first and third gearing R1, R3, but it will be appreciated that the freewheel clutches V1, V2 can also be connected to an output of the respective first and third gearing R1, R3.

The load-shifting clutches C1, C2 are, at least in this example, particularly arranged to be coupled and decoupled under load, i.e. while torque is transferred through the load-shifting clutch. The load-shifting clutches C1, C2 are for instance form-closed clutches. It will be appreciated that any of the load-shifting clutches may also be force-closed clutches, arranged to transfer torque in at least one rotational direction.

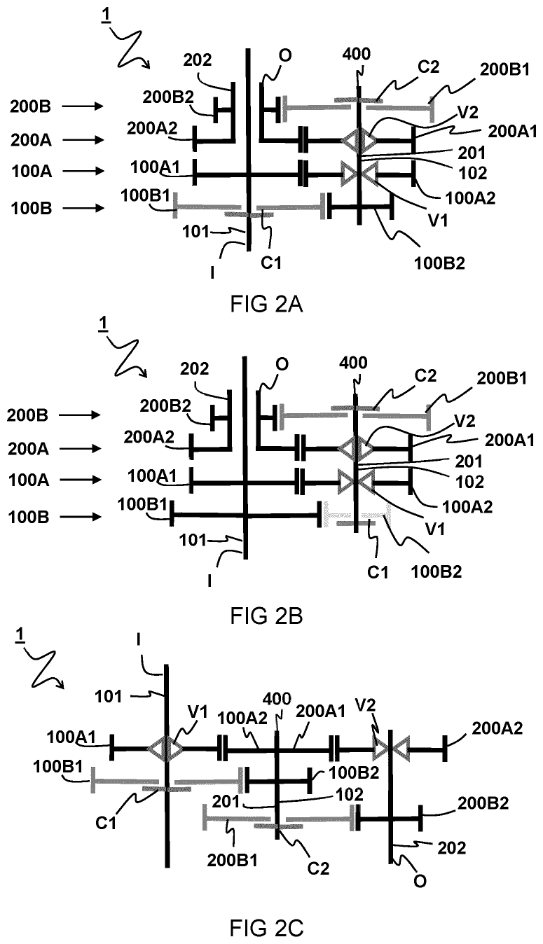

FIGS. 2A-2C show different schematic layouts of a transmission system 1, in particular the transmission system as shown in FIG. 1. The reference numbers in FIGS. 2A-2C correspond to those in FIG. 1, as explained in view of FIG. 1. FIGS. 2A-2C show different layouts in which the input I and the output O are connected via an intermediate member, here an intermediate shaft 400. The first transmission 100 acts between the input I and the intermediate shaft 400, and the second transmission 200 acts between the intermediate shaft and the output O.

FIGS. 2A and 2B show layouts of the transmission 1 in which the input I is associated with an input shaft, and the output O with an output shaft, and wherein the input shaft and the output shaft are coaxially arranged. FIG. 2C shows a layout of the transmission 1 in which the output shaft is offset from the input shaft. The first gearing R1 of the first transmission path 100A is in this example formed by gears 100A1 and 100A2. The second gearing R2 of the second transmission path 100B is formed by gears 100B1 and 100B2. The third gearing R3 of the third transmission path 200A is formed by gears 200A1 and 200A2. The fourth gearing R4 of the fourth transmission path 200B is formed by gears 200B1 and 200B2. The gears of each gearing R1-R4 can interact in such a way, e.g. mesh, to establish a transmission ratio between an input of the gearing and an output of the gearing. A desired transmission ratio of each of the gearings R1-R4 can for example be obtained selecting appropriate (relative) dimensions of the gears of each of the gearings R1-R4. For example, a transmission ratio of the first gearing R1 can be determined by a ratio of the number of teeth of gear 100A1 with respect to the gear 100A2.

FIG. 2B particularly shows a layout in which the first and second load-shifting clutches C1, C2, and the first and third freewheel clutches V1, V2 are arranged on the intermediate shaft 400.

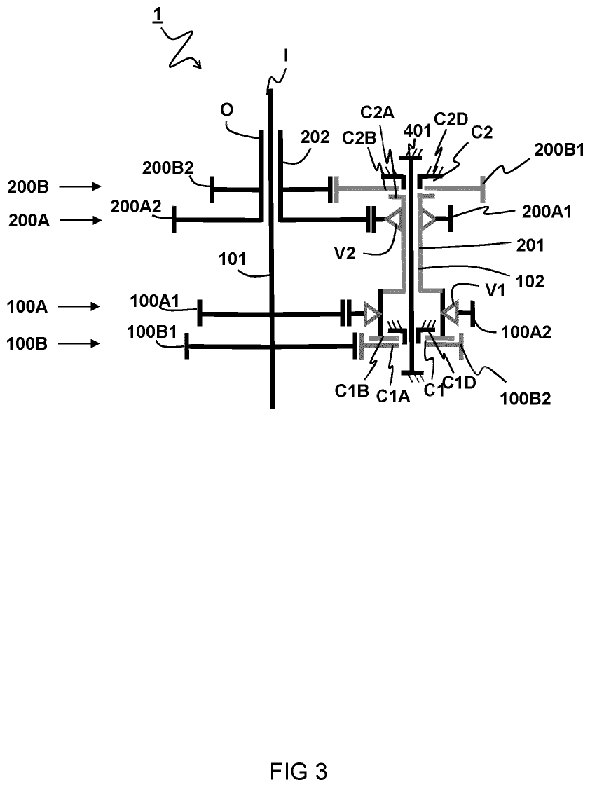

FIG. 3 shows another schematic layout of the transmission system 1 as shown in FIG. 1. The exemplary layout shown in FIG. 3 similar to the layout shown in FIG. 2B. Here, a stationary mounting shaft 401 is provided, e.g. for coupling to a frame of a bicycle. The example of FIG. 3 is particularly suitable for a crank transmission, where the transmission system 1 is provided between the crank and a front chainwheel of the bicycle.

In the example of FIG. 3, each of the clutches C1, C2 include a first rotatable unit C1A, C2A, for coupling to a clutch input, having at least one first abutment surface, and a second rotatable unit C1B, C2B for coupling to a clutch output, having at least one second abutment surface arranged for selectively engaging the first abutment surface of the first rotatable unit. The first CIA, C2A and second units C1B, C2B are, here, rotatable about the stationary mounting shaft 401. The first and second abutment surfaces can be adapted to each other so as to allow disengaging under load.

The clutches C1, C2 may comprise a third rotatable unit including at least one retaining member, arranged for selectively being in a first position or a second position relative to the second rotatable unit, wherein the at least one retaining member in the first position locks the at least one second abutment surface in engagement with the at least one first abutment surface for rotationally coupling the second rotatable unit C1B, C2B to the first rotatable unit C1A, C2A, and in the second position releases the at least one second abutment surface for disengagement of the at least one first abutment surface for decoupling the second rotatable unit C1B, C2B from the first rotatable unit C1A, C2A.

In the example of FIG. 3, the clutches C1, comprises respective actuator members for actuating the clutches C1, C2. The clutches C1, C2 may be actuated independently using the respective actuator members. The actuator members are, here, associated with the bicycle frame.

For actuating the clutches C1, C2, the clutches C1 and C2 may comprise a fourth unit C1D, C2D including a selector, the selector being arranged for selectively being in a gripping or non-gripping mode. The third rotatable units may each include at least one actuation member arranged for moving the third rotatable unit from a first position to a second position or from a second position to a first position relative to the second rotatable unit. The selector is in the gripping mode arranged for gripping the at least one actuation member for rotating the third rotatable unit from the first position to the second position or from the second position to the first position relative to the second rotatable unit C1B, C2B; the selector is in the non-gripping mode arranged for not engaging the at least one actuation member.

It will be appreciated that any of the clutches as described herein, e.g. in conjunction with any of the figures, may be similar to as described above. The clutches may particularly be a load-shifting clutch as described in WO2018/199757A2, WO2020/085911A2, or WO2021/080431A1, incorporated by reference in their entirety.

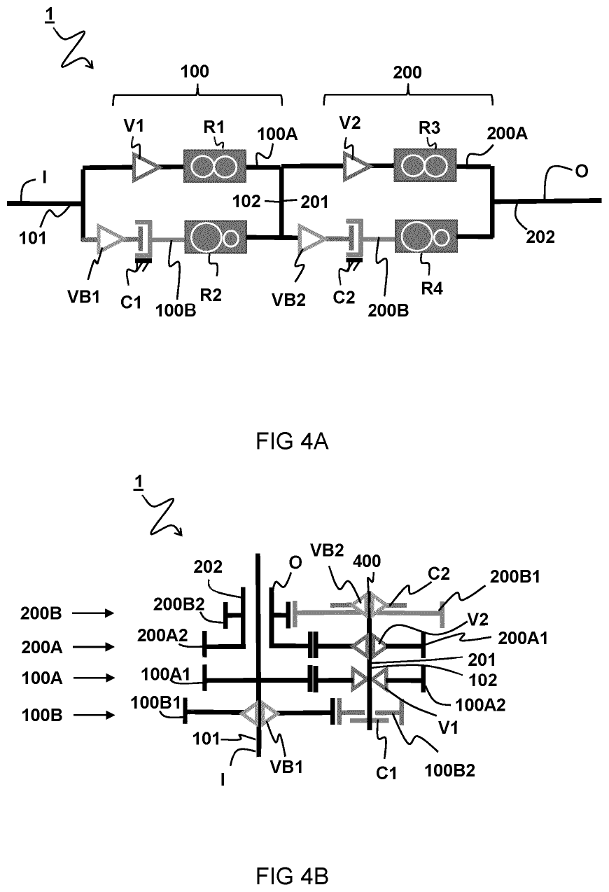

The transmission system 1 as shown in FIGS. 4A-4B is similar to those as shown in FIGS. 1 and 2A-2C and 3. Here, the first transmission 100 and the second transmission 200 each comprise a further clutch. In this example, the first transmission 100 comprises a second freewheel clutch VB1, and the second transmission 200 comprises a fourth freewheel clutch VB2. The second and fourth freewheel clutches VB1, VB2 are, here, connected to the respective inputs of the load-shifting clutches C1, C2, but it will be appreciated that the freewheel clutches VB1 and VB2 can also be connected to the respective outputs of the load-shifting clutches C1, C2. It may be preferred to connect the second and fourth freewheel clutches VB1, VB2 to the respective inputs of the load-shifting clutches C1, C2, so that the outputs of the load shifting clutches C1, C2 can keep rotating even without inputting any torque through their the inputs. This may facilitate coupling and/or decoupling of the load-shifting clutches C1, C2. The clutches VB1 and VB2 can be particularly arranged to allow for a reverse rotation direction of the output O, i.e. opposite a driving rotation direction, relative to the input I. Here, the first clutch is serially connected in the second transmission path 100B between the second freewheel clutch VB1 and the second gearing R2. The second clutch is, similarly, serially connected in the fourth transmission path 200B between the fourth freewheel clutch VB2 and the fourth gearing R4. It will be appreciated that other arrangements are also possible. FIG. 4B shows an exemplary (coaxial) layout of the transmission system 1 of FIG. 4A.

Six different examples of transmission ratios of the first, second, third and fourth gearings R1, R2, R3, R4, and the obtainable resultant system transmission ratios from the input I to the output O are given in tables 1-6. The system transmission ratios of the transmission system 1 are resultant from a multiplication of the transmission ratio of the first transmission (the first or second transmission ratio) and the transmission of the second transmission (the third or fourth transmission ratio). It will be appreciated that the given exemplary transmission ratios are given as decimal numbers, and can thus be approximations as the number of teeth of gears are discrete.

TABLE 1

| | C1 | C2 | System transmission ratio |
|---|---|---|---|
| R1 = 1.00 | Decoupled | Decoupled | 1.00 (R1*R3) |
| R2 = 1.20 | Coupled | Decoupled | 1.20 (R2*R3) |
| R3 = 1.00 | Decoupled | Coupled | 1.44 (R1*R4) |
| R4 = 1.44 | Coupled | Coupled | 1.73 (R2*R4) |

In the example of table 1, a substantially constant transmission step size of the transmission system 1 is obtained of, at least approximately, 1.20.

TABLE 2

| | C1 | C2 | System transmission ratio |
|---|---|---|---|
| R1 = 1.00 | Decoupled | Decoupled | 1.00 (R1*R3) |
| R2 = 1.24 | Coupled | Decoupled | 1.24 (R2*R3) |
| R3 = 1.00 | Decoupled | Coupled | 1.54 (R1*R4) |
| R4 = 1.54 | Coupled | Coupled | 1.91 (R2*R4) |

In the example of table 2, a substantially constant transmission step size of the transmission system 1 is obtained of, at least approximately, 1.24.

TABLE 3

| | C1 | C2 | System transmission ratio |
|---|---|---|---|
| R1 = 0.66 | Decoupled | Decoupled | 0.66 (R1*R3) |
| R2 = 1.00 | Coupled | Decoupled | 1.00 (R2*R3) |
| R3 = 1.00 | Decoupled | Coupled | 1.52 (R1*R4) |
| R4 = 2.30 | Coupled | Coupled | 2.30 (R2*R4) |

In the example of table 3, a substantially constant transmission step size of the transmission system 1 is obtained of, at least approximately, 1.52.

TABLE 4

| | C1 | C2 | System transmission ratio |
|---|---|---|---|
| R1 = 0.71 | Decoupled | Decoupled | 0.71 (R1*R3) |
| R2 = 1.00 | Coupled | Decoupled | 1.00 (R2*R3) |
| R3 = 1.00 | Decoupled | Coupled | 1.41 (R1*R4) |
| R4 = 2.00 | Coupled | Coupled | 2.00 (R2*R4) |

In the example of table 4, a substantially constant transmission step size of the transmission system 1 is obtained of, at least approximately, 1.41.

TABLE 5

| | C1 | C2 | System transmission ratio |
|---|---|---|---|
| R1 = 0.46 | Decoupled | Decoupled | 0.46 (R1*R3) |
| R2 = 1.00 | Coupled | Decoupled | 0.68 (R1*R4) |
| R3 = 1.00 | Decoupled | Coupled | 1.00 (R2*R3) |
| R4 = 1.47 | Coupled | Coupled | 1.47 (R2*R4) |

In the example of table 5, a substantially constant transmission step size of the transmission system 1 is obtained of, at least approximately, 1.47.

TABLE 6

| | C1 | C2 | System transmission ratio |
|---|---|---|---|
| R1 = 0.50 | Decoupled | Decoupled | 0.50 (R1*R3) |
| R2 = 1.00 | Coupled | Decoupled | 0.71 (R1*R4) |
| R3 = 1.00 | Decoupled | Coupled | 1.00 (R2*R3) |
| R4 = 1.44 | Coupled | Coupled | 1.41 (R2*R4) |

In the example of table 6, a substantially constant transmission step size of the transmission system 1 is obtained of, at least approximately, 1.41.

In the examples of tables 1-4, it generally holds that R1<R2, and that R3<R4, and that the respective transmission ratios of the first and second transmissions 100, 200 are chosen in accordance with the relation:

$$\frac{R 4}{R 3} = {( \frac{R 2}{R 1} )}^{2} .$$

In the examples of tables 5 and 6 it generally holds that R1<R2, and that R3<R4, and that the respective transmission ratios of the first and second transmissions 100, 200 are chosen in accordance with the relation:

$$\frac{R 4}{R 3} = {( \frac{R 2}{R 1} )}^{1 / 2} .$$

Also, for the examples in tables 1-2 it holds that R1*

$$R 4 = {( \frac{R 2}{R 1} )}^{2} .$$

In the examples of tables 3-6 it generally holds that R2=R3, particularly, R2=R3=1. In the examples of tables 3-4 it generally holds that R4=R1⁻². In the examples of tables 5-6 it generally holds that R4=R1^{-1/2}.

It may be desired to select one of the first and second transmission ratios R1, R2 as 1, and also to select one of the third and fourth transmission ratios R3, R4 as 1, since a unity transmission ratio could reduce friction losses in the transmission. For example, in view of tables 1 and 2, when a first one of the first transmission ratio R1 and the second transmission ratio R2 and also a first one of the third transmission ratio R3 and the fourth transmission ratio R4 are selected as a unity transmission ratio, a second one of the first transmission ratio R1 and the second transmission ratio R2 can be selected as corresponding to a desired transmission step size for the system transmission, and the second one of the third transmission ratio R3 and the fourth transmission ratio R4 can be selected as the square of the second transmission ratio R2.

In the examples of tables 1 and 2, the second one of the first and second transmission ratios R1, R2, as well as the second one of the third and fourth transmission ratios R3, R4 are larger than one. In the examples of tables 3-6, the second one of the first and second transmission ratios R1, R2 is smaller than one, and the second one of the third and fourth transmission ratios R3, R4 is larger than one, or vice versa.

In the example of tables 3 and 4, the largest transmission ratio and the smallest transmission ratio of the first and second transmissions 100, 200, here R4 and R1 respectively, are chosen in accordance with the relation: R4=R1⁻². In the example of tables 5 and 6, the largest transmission ratio and the smallest transmission ratio of the first and second transmissions 100, 200, here R4 and R1 respectively, are chosen in accordance with the relation: R4=R1^{-1/2}.

It will be appreciated that the first transmission 100 and the second transmission 200 are connected in series. Hence, the first transmission 100 can be positioned upstream from the second transmission 200, i.e. the first transmission driving the second transmission. It is also possible that the second transmission 200 is positioned upstream from the first transmission 100, i.e. the second transmission driving the first transmission. Thus, in view of the above examples, the first and second gearings R1, R2 can be upstream of the third and fourth gearings R3, R4. Alternatively, the third and fourth gearings R3, R4 can be upstream of the first and second gearings R1, R2.

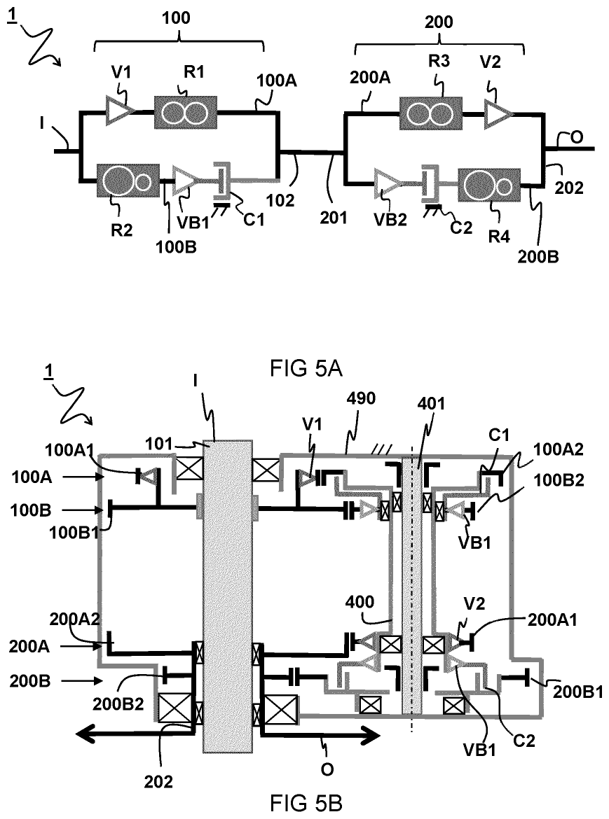

FIGS. 5A-5B show another example of a transmission system 1. The example of FIGS. 5A-5B is similar to the example shown in FIGS. 4A-4B, wherein the second freewheel clutch VB1 and the first clutch C1 are arranged in the second transmission path 100B, at the output of the second gearing R2, i.e. between the second gearing R2 and the first transmission output 102. Here, the second freewheel clutch VB1 is associated with the intermediate shaft 400. FIG. 5B shows a schematic layout of the transmission system 1 as shown in FIG. 5A. FIG. 5B particularly shows an example where the transmission system 1 forms a crank transmission for a bicycle, but it will be appreciated that the transmission system 1 can also be used as a hub transmission for a bicycle. In this example, the input I is associated with a crank spindle coupled to a crank of the bicycle, and the output O is associated with a front chain ring. In case of a hub transmission, the input I may be associated with a rear sprocket and the output with a hub shell of a driven wheel of the bicycle. FIG. 5B shows the transmission system 1 having a housing 490, which can for example be mounted to a frame of the bicycle. The housing 490 delimits a cavity in which components of the transmission system 1 can be sealed off from the environment; hence forming a sealed gearbox. It will be appreciated that exemplary transmission ratios given in tables 1-6, and described in view of FIGS. 4A and 4B are also obtainable by the exemplary transmission system 1 as shown in FIGS. 5A and 5B.

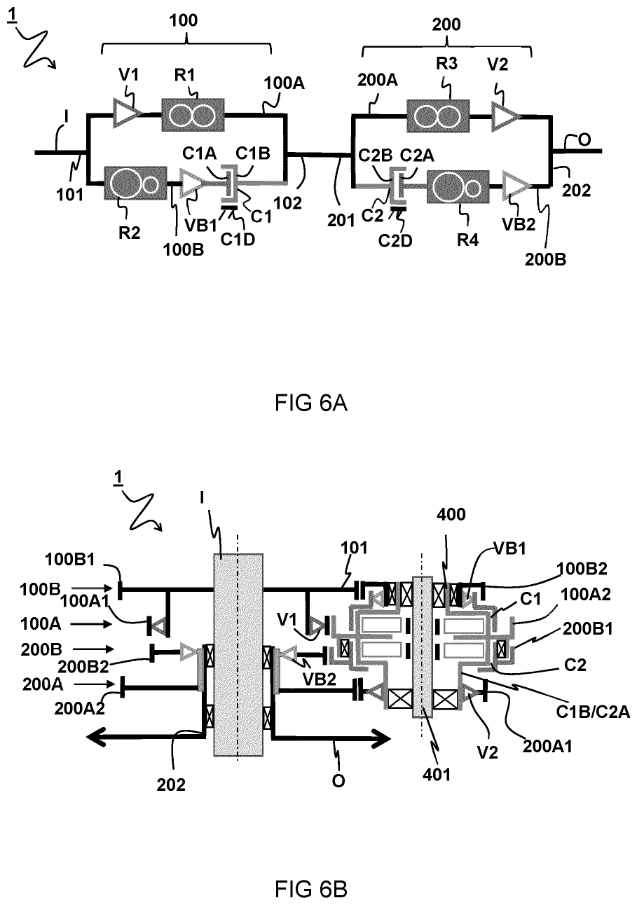

FIGS. 6A-6B shows another example of a transmission system 1, similar to the example shown in FIGS. 5A-5B, but wherein the fourth freewheel clutch VB2 is arranged at the output of the second clutch C2. In particular, the fourth gearing R4 is serially connected in the fourth transmission path 200B between the second clutch and the fourth freewheel clutch VB2. In this arrangement, the input of the second clutch C2 forms the second transmission input 201; and the output of the first clutch C1 forms the first transmission output 102. Hence, the first clutch output and the second clutch input can be coupled to each other. In this example, the first clutch output and the second clutch input are integrated, to obtain a particular compact and efficient setup. Here, the second rotatable unit C1B of the first clutch C1, here forming the output of the first clutch C1, is integrated with the second rotatable unit C2B of the second clutch C2, here forming the input of the second clutch C2. Also, in this example, gear 100A2, which forms the secondary gear of the first gearing R1, is coupled to, particularly integrated with, the second rotatable unit C1B of the first clutch C1. Gear 200B1, which forms the primary gear of the fourth gearing R4, is in this example coupled to, particularly integrated with, the first rotatable unit C2A of the second clutch C2, which forms the output of the second clutch C2.

It will be appreciated that the description in view of the exemplary transmission system shown in FIGS. 4A and 4B and regarding obtainable system transmission ratios therewith, also applies to the examples shown in FIGS. 5A, 5B and 6A, 6B.

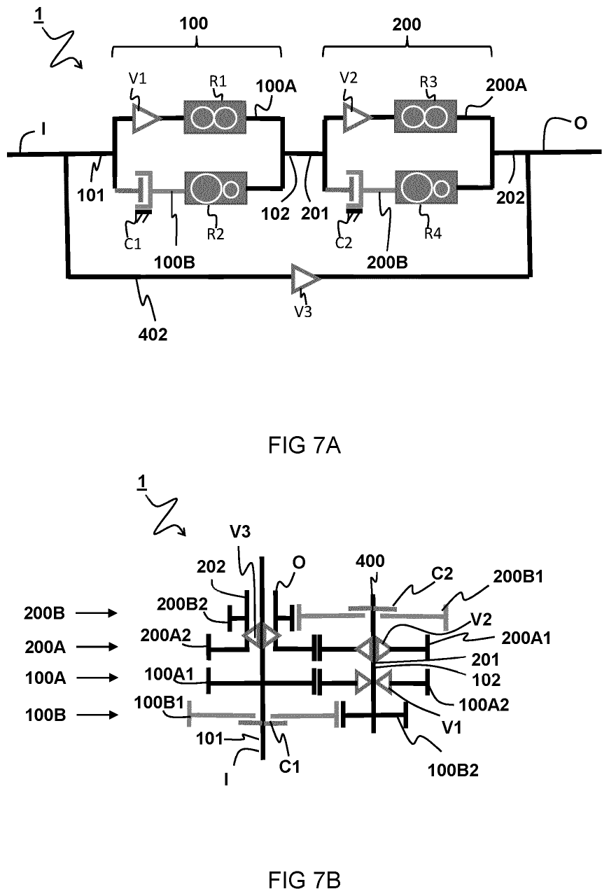

FIGS. 7A-7B shows another example of a transmission system 1. Here, a bypass transmission path 402 is provided between the input I and the output O parallel to the first 100 transmission and the second transmission 200. The bypass transmission path 402 includes a bypass clutch V3, here embodied as an actuatable freewheel clutch having an open state and a closed state. It will be appreciated that the bypass transmission path 402 may also only bypass the first transmission 100 or the second transmission 200. In this example, the bypass transmission path 402 provides a direct coupling between the input I and the output O. The bypass transmission path 402 may include a gearing, but in this example it does not. Hence, in this example, the bypass transmission path 402 provides a 1:1 transmission between the input I and the output O. FIG. 7B shows an exemplary (coaxial) layout of the transmission system of FIG. 7A.

The bypass transmission path 402 can provide an additional transmission ratio from the input I to the output O, i.e. in addition to transmission ratios obtainable by the serially connected first and second transmissions 100, 200. An example of system transmission ratios that are obtainable by the transmission system as shown in FIGS. 7A-7B is given in table 7.

TABLE 7

| | | | | System |
|---|---|---|---|---|
| | V3 | C1 | C2 | transmission ratio |
| Bypass = 1.00 | closed | (De)coupled | (De)coupled | 1.00 |
| R1 = 1.24 | open | Decoupled | Decoupled | 1.24 (R1*R3) |
| R2 = 1.54 | open | Coupled | Decoupled | 1.54 (R2*R3) |
| R3 = 1.00 | open | Decoupled | Coupled | 1.91 (R1*R4) |
| R4 = 1.54 | open | Coupled | Coupled | 2.36 (R2*R4) |

A five speed transmission system 1 is provided with the transmission system as shown in FIGS. 7A-7B and table 7. Further, in this example a substantially constant transmission step size of about 1.24 is obtained for the transmission system 1 as shown in FIGS. 7A-7B.

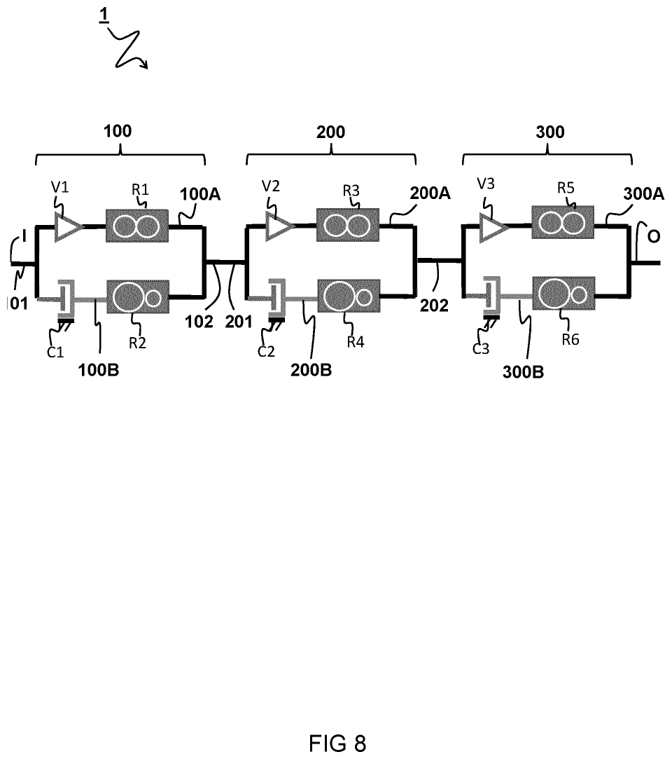

FIG. 8 shows an schematic example of transmission system 1, having a third transmission 300 connected in series with the first and second transmissions 100, 200. The third transmission 300 is selectively operable according to a fifth transmission ratio or a sixth transmission ratio, and has a third clutch, here a load-shifting clutch, C3 for switching the third transmission from the fifth transmission ratio to the sixth transmission ratio and/or vice versa. The third transmission 300 includes a fifth transmission path 300A and a sixth transmission path 300B parallel to the fifth transmission path 300A. At least one of the fifth and sixth transmission paths 300A, 300B includes the third load-shifting clutch C3. Here, the sixth 300B transmission path includes the third load-shifting clutch C3. Each of the fifth and sixth transmission paths 300A, 300B may include a gearing. In this example, the fifth transmission path 300A includes gearing R5 for providing the fifth transmission ratio, and the sixth transmission path 300B includes gearing R6 for providing the sixth transmission ratio. It will be appreciated that the transmission may be extended with additional transmissions, such as a fourth transmission, connected in series with the first and second transmissions 100, 200 and/or the third transmission 300. It will also be appreciated that the order in which the transmissions are serially connected from the input to the output can be altered. The transmission system 1 as shown in FIG. 8 is operable according to 8 transmission ratios. The transmission system 1 may also include a bypass transmission path, as described in view of FIGS. 7A-7B, parallel to any one or more of the first, second and third transmissions 100, 200, 300.

An example of system transmission ratios that are obtainable by the transmission system 1 as shown in FIG. 8 is given in table 8.

TABLE 8

| | | | | System transmission |
|---|---|---|---|---|
| | C1 | C2 | C3 | ratio |
| R1 = 1.00 | Decoupled | Decoupled | Decoupled | 1.00 (R1*R3*R5) |
| R2 = 1.20 | Coupled | Decoupled | Decoupled | 1.20 (R2*R3*R5) |
| R3 = 1.00 | Decoupled | Coupled | Decoupled | 1.44 (R1*R4*R5) |
| R4 = 1.44 | Coupled | Coupled | Decoupled | 1.73 (R2*R4*R5) |
| R5 = 1.00 | Decoupled | Decoupled | Coupled | 2.07 (R1*R3*R6) |
| R6 = 2.07 | Coupled | Decoupled | Coupled | 2.49 (R2*R3*R6) |
| | Decoupled | Coupled | Coupled | 2.99 (R1*R4*R6) |
| | Coupled | Coupled | Coupled | 3.58 (R2*R4*R6) |

Hence, an eight-speed transmission system 1 is provided with the transmission system 1 as shown in FIG. 8 and table 8, having a substantially constant transmission step size of about 1.2.

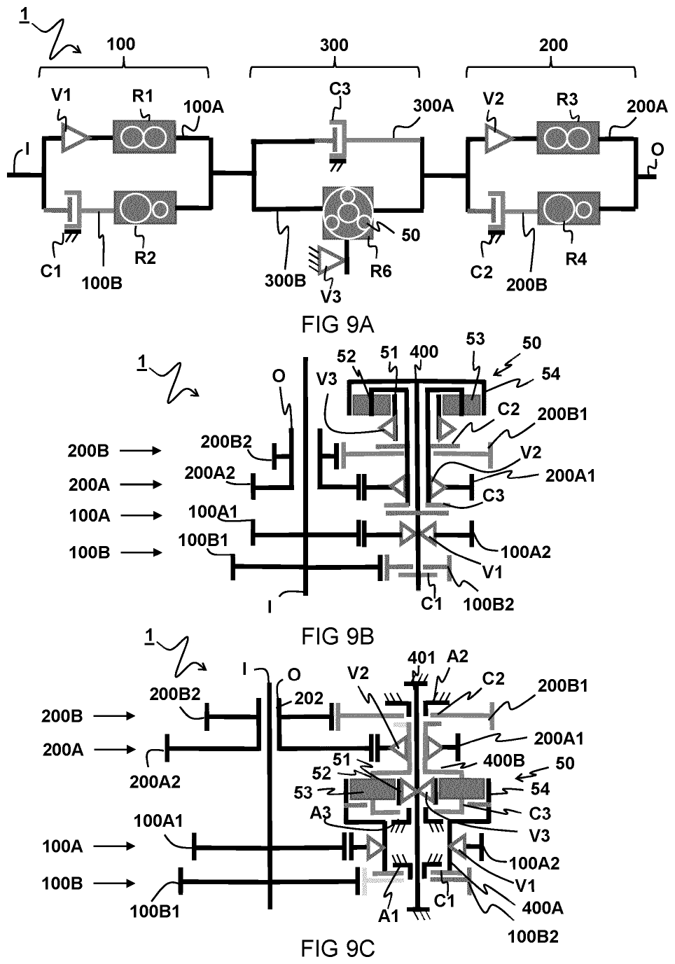

Any one of the transmissions described herein may include a planetary gear set. For example the gearing of any one of the transmission paths described herein, may include a planetary gear set. Such planetary gear set may include at least three rotational members, such as a sun gear 51, a planet carrier 52, for carrying one or more planet gears 53, and a ring gear 54. FIG. 9A shows an example of a transmission system 1 in which the third transmission 300 is physically positioned between the first transmission 100 and the second transmission 200, and wherein the third transmission 300 includes a planetary gear set 50. A clutch or brake system may be arranged for braking at least one of the rotational members or coupling at least two rotational members to each other. FIGS. 9B and 9C show exemplary layouts of the transmission system 1 as shown in FIG. 9A, being very compact. The planetary gear set 50 is provided in the sixth transmission path 300B, wherein the clutch C3 of the third transmission is arranged parallel to the planetary gear set 50 in the fifth transmission path 300A. The clutch C3 can accordingly be used for selectively shifting between a fifth transmission ratio and a sixth transmission ratio of the third transmission 300. Here the sixth transmission ratio is obtained with the planetary gear set 50. The fifth transmission ratio is, in this example, a 1:1 transmission ratio.

In the exemplary layouts of FIGS. 9B and 9C, the planetary gear set is arranged between a first intermediate shaft 400A and a second intermediate shaft 400B. Here, the output of the first transmission is couplable to the first intermediate shaft 400A, and the input of the second transmission is couplable to the second intermediate shaft 400B. Here, the third clutch C3 can couple the first intermediate shaft 400A directly to the second intermediate shaft 400B. The first and second intermediate shafts 400A, 400B are, in this example, rotatable about a stationary mounting shaft 401, e.g. for mounting to a bicycle frame.

In this example, the output of the first transmission 100 is connectable to the ring gear 54 of the planetary gear set 50. Input of the second transmission 200 is connectable to planet carrier 52 of the planetary gear set 50 via the planet gears 53. Hence, the sixth transmission ratio can, here, be formed between the ring gear 54 and the planet carrier 52. The sun gear 51 is in this example braked, here in one direction using a one way clutch V3. Clutch C3 can be used to bypass the planetary gear set 50. Here, the clutch C3 connects the output of the first transmission 100 directly to the input of the second transmission 200 in a coupled state of the clutch C3. In a decoupled state of the clutch C3, torque is transmitted via the sixth transmission path 300B through the planetary gear set 50. An example of system transmission ratios that are obtainable by the transmission system 1 as shown in FIGS. 9A-9C is given in table 9.

TABLE 9

| | | | | System transmission |
|---|---|---|---|---|
| | C1 | C2 | C3 | ratio |
| R1 = 1.14 | Decoupled | Decoupled | Decoupled | 0.50 (R1*R3*R6) |
| R2 = 1.38 | Coupled | Decoupled | Decoupled | 0.61 (R2*R3*R6) |
| R3 = 0.64 | Decoupled | Decoupled | Coupled | 0.72 (R1*R3*R5) |
| R4 = 1.38 | Coupled | Decoupled | Coupled | 0.88 (R2*R3*R5) |
| R5 = 1.00 | Decoupled | Coupled | Decoupled | 1.08 (R1*R4*R6) |
| R6 = 0.69 | Coupled | Coupled | Decoupled | 1.31 (R2*R4*R6) |
| | Decoupled | Coupled | Coupled | 1.57 (R1*R4*R5) |
| | Coupled | Coupled | Coupled | 1.90 (R2*R4*R5) |

In the example of FIG. 9C, the clutches C1, C2, C3 are particularly shown to have respective actuators A1, A2, A3, similar to as described in conjunction with the example of FIG. 3.

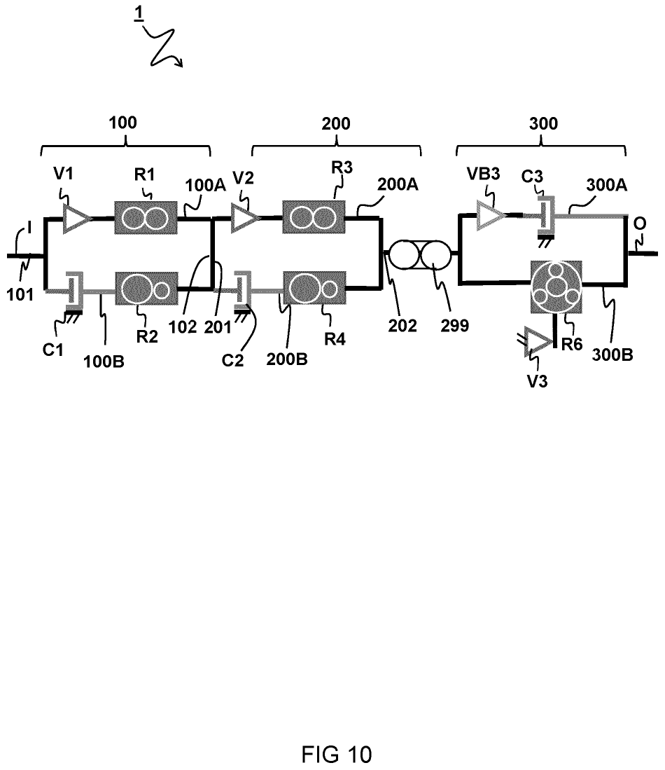

In the example of FIG. 10, the first and second transmission 100, 200 are arranged between the crank of a bicycle and an input of a torque transfer system 299, such as a chain, belt or shaft. The first and second transmission 100, 200 are e.g. housed in a common housing at the crank. The third transmission 300 of the transmission system 1 is arranged between an output of the torque transfer system and a wheel hub of a driven wheel of the bicycle. The third transmission 300 is e.g. housed in a wheel axle assembly.

Two examples of system transmission ratios that are obtainable by the transmission system 1 as shown in FIG. 10 are given in tables 10 and 11. The example in table 10 shows an eight-speed transmission system 1 with a substantially constant transmission step size of about 1.2. The example in table 11 shows an eight-speed transmission system 1 with a substantially constant transmission step size of about 1.24. Each example includes a reduction system transmission ratio, indicated by a transmission ratio of less than 1.

TABLE 10

| | | | | System transmission |
|---|---|---|---|---|
| | C1 | C2 | C3 | ratio |
| R1 = 1.00 | Decoupled | Decoupled | Decoupled | 0.69 (R1*R3*R6) |
| R2 = 1.20 | Coupled | Decoupled | Decoupled | 0.83 (R2*R3*R6) |
| R3 = 1.00 | Decoupled | Decoupled | Coupled | 1 (R1*R3*R5) |
| R4 = 2.07 | Coupled | Decoupled | Coupled | 1.20 (R2*R3*R5) |
| R5 = 1.00 | Decoupled | Coupled | Decoupled | 1.44 (R1*R4*R6) |
| R6 = 0.69 | Coupled | Coupled | Decoupled | 1.73 (R2*R4*R6) |
| | Decoupled | Coupled | Coupled | 2.07 (R1*R4*R5) |
| | Coupled | Coupled | Coupled | 2.48 (R2*R4*R5) |

TABLE 11

| | C1 | C2 | C3 | System transmission ratio |
|---|---|---|---|---|
| R1 = 1.00 | Decoupled | Decoupled | Decoupled | 0.65 (R1*R3*R6) |
| R2 = 1.24 | Coupled | Decoupled | Decoupled | 0.81 (R2*R3*R6) |
| R3 = 1.00 | Decoupled | Decoupled | Coupled | 1 (R1*R3*R5) |
| R4 = 2.36 | Coupled | Decoupled | Coupled | 1.24 (R2*R3*R5) |
| R5 = 1.00 | Decoupled | Coupled | Decoupled | 1.53 (R1*R4*R6) |
| R6 = 0.65 | Coupled | Coupled | Decoupled | 1.90 (R2*R4*R6) |
| | Decoupled | Coupled | Coupled | 2.36 (R1*R4*R5) |
| | Coupled | Coupled | Coupled | 2.93 (R2*R4*R5) |

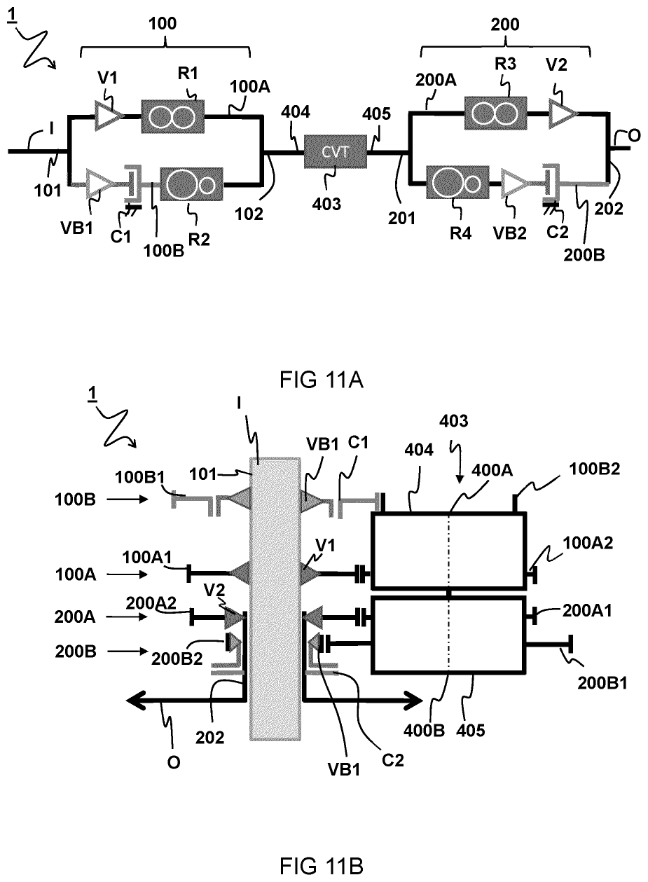

The exemplary transmission system 1 as shown in FIGS. 11A, 11B comprises a continuously variable transmission (CVT) 403 connected in series with the first transmission 100 and the second transmission 200, in particular between the first transmission 100 and the second transmission 200. The first transmission 100 and the second transmission 200 as shown in FIG. 11A are similar to the transmissions as shown in e.g. FIG. 4A. Here, the load-shifting clutch C2, and the freewheel clutch VB2, are connected to an output of gearing R4. It is preferred that clutches C1 and C2 are load-shifting clutches, arranged to be coupled and/or decoupled under load, however, it will be appreciated clutches C1 and C2 need not be load-shifting clutches.

In this example, the output 102 of the first transmission 100 is connected to an input 404 of the CVT 403. An output 405 of the CVT 403 is connected to the input 201 of the second transmission 200. The CVT 403 is arranged to provide a transmission ratio between the CVT input 404 and the CVT output 405. The CVT 403 can for example be operable according to at least a seventh transmission ratio and a eighth transmission ratio, and additionally a ninth transmission ratio etc. between the input 404 and output 405. The CVT 403 may hence be arranged to be operable according to various transmission ratios within a continuous range of CVT transmission ratios. The CVT 403 may particularly be arranged to be operable according to a predetermined finite set of transmission ratios within the continuous range of CVT transmission ratios. For example, the CVT 403 may be operable according to any selected one or the predetermined finite set of CVT transmission ratios, such as the seventh transmission ratio, the eighth transmission ratio, etc. The transmission system 1 may comprise a CVT actuator arranged for actuating a transmission ratio change of the CVT. In this example, the CVT input 404 is connected to the output 102 of the first transmission 100, and is hereto provided with gear 100A2 for meshing with gear 100A1 to form the first transmission path 100A, and with gear 100B2 for meshing with gear 100B1 for forming the second transmission path 100B. The CVT output 405 is connected to the second input 201 of the second transmission 200, and is hereto provided with gear 200A1 for meshing with gear 200A2 for forming the third transmission path 200A and gear 200B1 for meshing with gear 200B2 for forming the fourth transmission path 200B.

The CVT 403 is in this example associated with an intermediate shaft 400, which is offset from the input shaft I and the output shaft O. The intermediate shaft 400 is in this example be a split shaft, comprising a first intermediate shaft 400A and a second intermediate shaft 400B that are rotatable relative to each other. The first transmission 100 is formed between the input shaft I and the first intermediate shaft 400A. The CVT 403 is configured to apply a transmission ratio, e.g. a seventh and eighth transmission ratio, between the first intermediate shaft 400A and the second intermediate shaft 400B. The second transmission 200 is formed between the intermediate shaft 400B and the output shaft O.

It will be appreciated that the CVT can be embodied in various ways. In this example, the CVT is a ratcheting type CVT, which uses freewheel or one-way drive modules. However, other types of CVTs can be used such as a pully-based CVT, a toroidal CVT, a hydrostatic CVT, an electrical CVT, a cone CVT, an epicyclic CVT, a friction-disk CVT, a magnetic CVT, etc. The CVT referred to herein may particularly be a CVT as described in co-pending application NL2028686, which is hereby incorporated by reference in its entirety.

The transmission system 1 is operable according to various transmission ratios, wherein the CVT 403 provides for (pre)programmable transmission ratios. For example, table 12 shows an example of system transmission ratios that is obtainable by the transmission system 1 as shown in FIG. 11A. The example of table 12 shows a seven-speed transmission system 1 with a substantially constant transmission step size of about 1.25.

TABLE 12

| | C1 | C2 | RCVT | System transmission ratio |
|---|---|---|---|---|
| R1 = 0.90 | Decoupled | Decoupled | 1.00 | 0.8 (R1*R3*RCVT) |
| R2 = 1.28 | Decoupled | Decoupled | 1.25 | 1 (R1*R3*RCVT) |
| R3 = 0.89 | Coupled | Decoupled | 1.10 | 1.25 (R2*R3*RCVT) |
| R4 = 1.79 | Coupled | Decoupled | 1.37 | 1.56 (R2*R3*RCVT) |
| | Decoupled | Coupled | 1.21 | 1.95 (R1*R4*RCVT) |
| | Coupled | Coupled | 1.07 | 2.45 (R2*R4*RCVT) |
| | Coupled | Coupled | 1.33 | 3.05 (R2*R4*RCVT) |

In the example of table 12, each consecutive shift changes the system transmission ratio with, approximately, 25%. The transmission ratios of the CVT 403, RCVT, can be preprogrammed. The CVT can accordingly by controlled to switch from one preprogrammed transmission ratio to another.

Table 13 shows another example of system transmission ratios that are obtainable by a transmission system 1 as shown in FIG. 11A. This example shows a 10-speed transmission system 1, with a constant transmission step size of about 1.17.

TABLE 13

| | C1 | C2 | RCVT | System transmission ratio |
|---|---|---|---|---|
| R1 = 0.90 | Decoupled | Decoupled | 1.00 | 0.80 (R1*R3*RCVT) |
| R2 = 1.28 | Decoupled | Decoupled | 1.17 | 0.94 (R1*R3*RCVT) |
| R3 = 0.89 | Decoupled | Decoupled | 1.38 | 1.10 (R1*R3*RCVT) |
| R4 = 1.79 | Coupled | Decoupled | 1.12 | 1.28 (R2*R3*RCVT) |
| | Coupled | Decoupled | 1.32 | 1.50 (R2*R3*RCVT) |
| | Decoupled | Coupled | 1.09 | 1.75 (R1*R4*RCVT) |
| | Decoupled | Coupled | 1.27 | 2.05 (R1*R4*RCVT) |
| | Coupled | Coupled | 1.05 | 2.40 (R2*R4*RCVT) |
| | Coupled | Coupled | 1.23 | 2.81 (R2*R4*RCVT) |
| | Coupled | Coupled | 1.43 | 3.29 (R2*R4*RCVT) |

In the example of table 13, each consecutive shift changes the system transmission ratio with, approximately, 17%. The transmission ratios of the CVT 403 (RCVT) can be preprogrammed. The CVT can accordingly by controlled to switch from one preprogrammed transmission ratio to another.

Table 14 shows another example of system transmission ratios that are obtainable by a transmission system 1 as shown in FIG. 11A. This example shows a 16-speed transmission system 1, with a constant transmission step size of about 1.10.

TABLE 14

| | C1 | C2 | RCVT | System transmission ratio |
|---|---|---|---|---|
| R1 = 0.90 | Decoupled | Decoupled | 1.00 | 0.80 (R1*R3*RCVT) |
| R2 = 1.28 | Decoupled | Decoupled | 1.10 | 0.88 (R1*R3*RCVT) |
| R3 = 0.89 | Decoupled | Decoupled | 1.21 | 0.97 (R1*R3*RCVT) |
| R4 = 1.79 | Decoupled | Decoupled | 1.32 | 1.06 (R1*R3*RCVT) |
| | Coupled | Decoupled | 1.03 | 1.17 (R2*R3*RCVT) |
| | Coupled | Decoupled | 1.13 | 1.29 (R2*R3*RCVT) |
| | Coupled | Decoupled | 1.25 | 1.42 (R2*R3*RCVT) |
| | Coupled | Decoupled | 1.37 | 1.56 (R2*R3*RCVT) |
| | Decoupled | Coupled | 1.06 | 1.71 (R1*R4*RCVT) |
| | Decoupled | Coupled | 1.16 | 1.87 (R1*R4*RCVT) |
| | Decoupled | Coupled | 1.29 | 2.07 (R1*R4*RCVT) |
| | Decoupled | Coupled | 1.42 | 2.28 (R1*R4*RCVT) |
| | Coupled | Coupled | 1.09 | 2.51 (R2*R4*RCVT) |
| | Coupled | Coupled | 1.20 | 2.76 (R2*R4*RCVT) |
| | Coupled | Coupled | 1.33 | 3.04 (R2*R4*RCVT) |
| | Coupled | Coupled | 1.45 | 3.34 (R2*R4*RCVT) |

In the example of table 14, each consecutive shift changes the system transmission ratio with, approximately, 10%. The transmission ratios of the CVT 403 (RCVT) can be preprogrammed. The CVT can accordingly by controlled to switch from one preprogrammed transmission ratio to another.

Table 15 shows another example of system transmission ratios that are obtainable by a transmission system 1 as shown in FIG. 11A. This example shows a 16-speed transmission system 1, with a constant transmission step size of about 1.12.

TABLE 15

| | C1 | C2 | RCVT | System transmission ratio |
|---|---|---|---|---|
| R1 = 1.11 | Decoupled | Decoupled | 1.00 | 0.60 (R1*R3*RCVT) |
| R2 = 1.73 | Decoupled | Decoupled | 1.12 | 0.67 (R1*R3*RCVT) |
| R3 = 0.55 | Decoupled | Decoupled | 1.25 | 0.75 (R1*R3*RCVT) |
| R4 = 1.35 | Decoupled | Decoupled | 1.40 | 0.84 (R1*R3*RCVT) |
| | Coupled | Decoupled | 1.00 | 0.94 (R2*R3*RCVT) |
| | Coupled | Decoupled | 1.12 | 1.06 (R2*R3*RCVT) |
| | Coupled | Decoupled | 1.25 | 1.18 (R2*R3*RCVT) |
| | Coupled | Decoupled | 1.40 | 1.33 (R2*R3*RCVT) |
| | Decoupled | Coupled | 1.00 | 1.49 (R1*R4*RCVT) |
| | Decoupled | Coupled | 1.12 | 1.66 (R1*R4*RCVT) |
| | Decoupled | Coupled | 1.25 | 1.86 (R1*R4*RCVT) |
| | Decoupled | Coupled | 1.40 | 2.09 (R1*R4*RCVT) |
| | Coupled | Coupled | 1.00 | 2.34 (R2*R4*RCVT) |
| | Coupled | Coupled | 1.12 | 2.62 (R2*R4*RCVT) |
| | Coupled | Coupled | 1.25 | 3.93 (R2*R4*RCVT) |
| | Coupled | Coupled | 1.40 | 3.28 (R2*R4*RCVT) |

In the example of table 15, each consecutive shift changes the system transmission ratio with, approximately, 12%. The transmission ratios of the CVT 403 (RCVT) can be preprogrammed. In this example, the CVT 403 only is preprogrammed to be operable according to four different transmission ratios. The CVT can be controlled to switch from one preprogrammed transmission ratio to another.

In this example of table 15, the first transmission ratio, here R1=1.11, is obtained by a meshing 63-teeth primary gear 100A1 and a 57-teeth secondary gear 100A2; the second transmission ratio, here R2=1.73, is obtained by a meshing 76-teeth primary gear 100B1 and a 44-teeth secondary gear 100B2; the third transmission ratio, here R3=0.55, is obtained by a meshing 78-teeth primary gear 200A1 and a 42-teeth secondary gear 200A2; and the fourth transmission ratio, here R4=1.35, is obtained by a meshing 51-teeth primary gear 200B1 and a 69-teeth secondary gear 200B2. These gear pairs are such that all summed number of teeth for each meshing gear pair are equal. In this case the summed number of teeth for each meshing gear pair is 120 teeth. The gear pairs are particularly such that a sum of radii of each primary-secondary gear pair is the same for all gear pairs. Hence, the primary gears can be arranged to rotate about a common primary axis, here defined by the coaxial input I and output O shaft, and the secondary gears can be arranged to rotate about a common secondary axis, here defined by the intermediate shaft 400, parallel to the primary axis, while each pair of gears can be permanently meshingly engaged. The clutches C1 and C2 can accordingly be used to select a desired gear pair for transferring torque, and hence a desired transmission ratio, without having to displace gears. This exemplary first, second, third, and fourth transmission ratios and associated gear teething is summarized in table 16. Other examples are given in tables 17-20.

TABLE 16

(Gear centre distance: e.g. 60 mm)

| | Primary gear | Secondary gear | Sum | Ratio |
|---|---|---|---|---|
| R1 | 63 teeth | 57 teeth | 120 teeth | 1.11 |
| R2 | 76 teeth | 44 teeth | 120 teeth | 1.73 |
| R3 | 78 teeth | 42 teeth | 120 teeth | 0.54 |
| R4 | 51 teeth | 69 teeth | 120 teeth | 1.35 |

TABLE 17

(Gear centre distance: e.g. 58 mm)

| | Primary gear | Secondary gear | Sum | Ratio |
|---|---|---|---|---|
| R1 | 52 teeth | 64 teeth | 116 teeth | 0.81 |
| R2 | 65 teeth | 51 teeth | 116 teeth | 1.27 |
| R3 | 71 teeth | 45 teeth | 116 teeth | 0.63 |
| R4 | 46 teeth | 70 teeth | 116 teeth | 1.52 |

TABLE 18

(Gear centre distance: e.g. 58 mm)

| | Primary gear | Secondary gear | Sum | Ratio |
|---|---|---|---|---|
| R1 | 52 teeth | 64 teeth | 116 teeth | 0.81 |
| R2 | 62 teeth | 54 teeth | 116 teeth | 1.15 |
| R3 | 66 teeth | 50 teeth | 116 teeth | 0.76 |
| R4 | 46 teeth | 70 teeth | 116 teeth | 1.52 |

TABLE 19

(Gear centre distance: e.g. 58 mm)

| | Primary gear | Secondary gear | Sum | Ratio |
|---|---|---|---|---|
| R1 | 52 teeth | 64 teeth | 116 teeth | 0.81 |
| R2 | 57 teeth | 59 teeth | 116 teeth | 0.97 |
| R3 | 66 teeth | 50 teeth | 116 teeth | 0.76 |
| R4 | 46 teeth | 70 teeth | 116 teeth | 1.52 |

TABLE 20

(Gear centre distance: e.g. 58 mm)

| | Primary gear | Secondary gear | Sum | Ratio |
|---|---|---|---|---|
| R1 | 55 teeth | 61 teeth | 116 teeth | 0.90 |
| R2 | 68 teeth | 48 teeth | 116 teeth | 1.42 |
| R3 | 71 teeth | 45 teeth | 116 teeth | 0.63 |
| R4 | 46 teeth | 70 teeth | 116 teeth | 1.52 |

The examples of tables 12-15 show a relation between the system transmission ratios having a, substantially, constant transmission ratio step between consecutive system transmission ratios. It will be appreciated that any relation can also be obtained using the CVT 403, e.g. progressively increasing and/or decreasing transmission ratio steps between consecutive system transmission ratios. The CVT 403 can be operated accordingly, e.g. using a control unit.

Table 16 shows another example of system transmission ratios obtainable by a transmission system as shown in FIG. 11A. This example includes transmission ratios R1, R2, R3, R4, corresponding to the example of table 4. The CVT 403 is preprogrammed to operate according to various transmission ratios RCVT, within a continuous range of transmission ratios.

TABLE 16

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.07 | 0.76 (R1*R3*RCVT) |
| R3 = 1.00 | Decoupled | Decoupled | 1.15 | 0.82 (R1*R3*RCVT) |
| R4 = 2.00 | Decoupled | Decoupled | 1.23 | 0.87 (R1*R3*RCVT) |
| | Decoupled | Decoupled | 1.32 | 0.94 (R1*R3*RCVT) |
| | Coupled | Decoupled | 1.00 | 1.00 (R2*R3*RCVT) |
| | Coupled | Decoupled | 1.07 | 1.07 (R2*R3*RCVT) |
| | Coupled | Decoupled | 1.15 | 1.15 (R2*R3*RCVT) |
| | Coupled | Decoupled | 1.23 | 1.23 (R2*R3*RCVT) |
| | Coupled | Decoupled | 1.32 | 1.32 (R2*R3*RCVT) |
| | Decoupled | Coupled | 1.00 | 1.42 (R1*R4*RCVT) |
| | Decoupled | Coupled | 1.07 | 1.52 (R1*R4*RCVT) |
| | Decoupled | Coupled | 1.15 | 1.63 (R1*R4*RCVT) |
| | Decoupled | Coupled | 1.23 | 1.75 (R1*R4*RCVT) |
| | Decoupled | Coupled | 1.32 | 1.88 (R1*R4*RCVT) |
| | Coupled | Coupled | 1.00 | 2.00 (R2*R4*RCVT) |
| | Coupled | Coupled | 1.07 | 2.14 (R2*R4*RCVT) |
| | Coupled | Coupled | 1.15 | 2.30 (R2*R4*RCVT) |
| | Coupled | Coupled | 1.23 | 2.46 (R2*R4*RCVT) |
| | Coupled | Coupled | 1.32 | 2.64 (R2*R4*RCVT) |
| | Coupled | Coupled | 1.42 | 2.83 (R2*R4*RCVT) |

Compared to table 4, the CVT 403 provides intermediate transmission ratio steps, between the system transmission ratios obtainable with only the first and second transmissions 100, 200. Hence, the first and second transmission 100, 200 combined can provide a spread of system transmission ratios, while the CVT 403 can be used to provide appropriate, intermediate, steps between consecutive ratios. The CVT 403 can also be used to extend the range of system transmission ratios provided by the first and second transmissions 100, 200.

Here, the consecutive system transmission steps are constant, here of 7%, providing a linear set of, here twenty-one, system transmission ratios. It will be appreciated that nonlinear sets may also be obtained by programming the CVT transmission ratios RCVT accordingly. For example, a progressively increasing or decreasing transmission steps may be obtained. The steps may even be changed on-the-fly, i.e. during operation of the transmission, e.g. by properly selecting or re-programming of the CVT transmission ratios RCVT.

In this example, the transmission ratios are chosen such that the number of different CVT transmission ratios RCVT is less than the number of system transmission ratios. The number of different CVT transmission ratios RCVT is particularly less than half the number of system transmission ratios, more particularly about 25% of the number of system transmission ratios. The CVT 403 is, here, operated according to five different transmission ratios, particularly 1.00, 1.07, 1.15, 1.23 and 1.32, wherein an additional CVT transmission ratio of 1.42 is provided for extending the range provided by the first and second transmissions 100, 200.

Tables 17-19 provide other examples of sets of system transmission ratios obtainable by a transmission system as shown in FIG. 11A, wherein the transmission ratios R1, R2, R3, R4, again correspond to the example of table 4. Compared to table 16, instead of a 21-speed transmission system, tables 17-19 respectively show a 17-speed, 13-speed and 9-speed transmission system. The overall range of system transmission ratios are substantially the same between the examples, here about 400%, but compared to table 16, the CVTs 403 provide fewer intermediate steps.

TABLE 17

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.09 | 0.77 (R1*R3*RCVT) |
| R3 = 1.00 | Decoupled | Decoupled | 1.19 | 0.84 (R1*R3*RCVT) |
| R4 = 2.00 | Decoupled | Decoupled | 1.30 | 0.92 (R1*R3*RCVT) |
| | Coupled | Decoupled | 1.00 | 1.00 (R2*R3*RCVT) |
| | Coupled | Decoupled | 1.09 | 1.09 (R2*R3*RCVT) |
| | Coupled | Decoupled | 1.19 | 1.19 (R2*R3*RCVT) |
| | Coupled | Decoupled | 1.30 | 1.30 (R2*R3*RCVT) |
| | Decoupled | Coupled | 1.00 | 1.41 (R1*R4*RCVT) |
| | Decoupled | Coupled | 1.09 | 1.54 (R1*R4*RCVT) |
| | Decoupled | Coupled | 1.19 | 1.68 (R1*R4*RCVT) |
| | Decoupled | Coupled | 1.30 | 1.83 (R1*R4*RCVT) |
| | Coupled | Coupled | 1.00 | 2.00 (R2*R4*RCVT) |
| | Coupled | Coupled | 1.09 | 2.18 (R2*R4*RCVT) |
| | Coupled | Coupled | 1.19 | 2.38 (R2*R4*RCVT) |
| | Coupled | Coupled | 1.30 | 2.59 (R2*R4*RCVT) |
| | Coupled | Coupled | 1.41 | 2.82 (R2*R4*RCVT) |

TABLE 18

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.12 | 0.80 (R1*R3*RCVT) |
| R3 = 1.00 | Decoupled | Decoupled | 1.25 | 0.89 (R1*R3*RCVT) |
| R4 = 2.00 | Coupled | Decoupled | 1.00 | 1.00 (R2*R3*RCVT) |
| | Coupled | Decoupled | 1.12 | 1.12 (R2*R3*RCVT) |
| | Coupled | Decoupled | 1.25 | 1.25 (R2*R3*RCVT) |
| | Decoupled | Coupled | 1.00 | 1.42 (R1*R4*RCVT) |
| | Decoupled | Coupled | 1.12 | 1.59 (R1*R4*RCVT) |
| | Decoupled | Coupled | 1.25 | 1.78 (R1*R4*RCVT) |
| | Coupled | Coupled | 1.00 | 2.00 (R2*R4*RCVT) |
| | Coupled | Coupled | 1.12 | 2.24 (R2*R4*RCVT) |
| | Coupled | Coupled | 1.25 | 2.51 (R2*R4*RCVT) |
| | Coupled | Coupled | 1.40 | 2.81 (R2*R4*RCVT) |

TABLE 19

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.19 | 0.84 (R1*R3*RCVT) |
| R3 = 1.00 | Coupled | Decoupled | 1.00 | 1.00 (R2*R3*RCVT) |
| R4 = 2.00 | Coupled | Decoupled | 1.19 | 1.19 (R2*R3*RCVT) |
| | Decoupled | Coupled | 1.00 | 1.42 (R1*R4*RCVT) |
| | Decoupled | Coupled | 1.19 | 1.68 (R1*R4*RCVT) |
| | Coupled | Coupled | 1.00 | 2.00 (R2*R4*RCVT) |
| | Coupled | Coupled | 1.19 | 2.37 (R2*R4*RCVT) |
| | Coupled | Coupled | 1.40 | 2.81 (R2*R4*RCVT) |

FIG. 11B shows an exemplary schematic layout of the transmission system 1 as shown in FIG. 11A. In the example of FIG. 11B, the input shaft and the output shaft are coaxially arranged with respect to one another, but it will be appreciated that an offset arrangement, in which the input shaft and the output shaft are offset with respect to one another, can also be provided. It will further be appreciated that the CVT 403 and/or the input I and/or the output O can be coaxially arranged. Here the CVT 403, being associated with an intermediate axis 406, is provided offset from the input and output shafts, to obtain a particular compact setup. The first transmission output 102 and the CVT input 404 are connected to one another. The CVT output 405 and the second transmission input 201 are also connected to one another. A continuously variable transmission ratio may be provided between the CVT input 404 and CVT output 405.

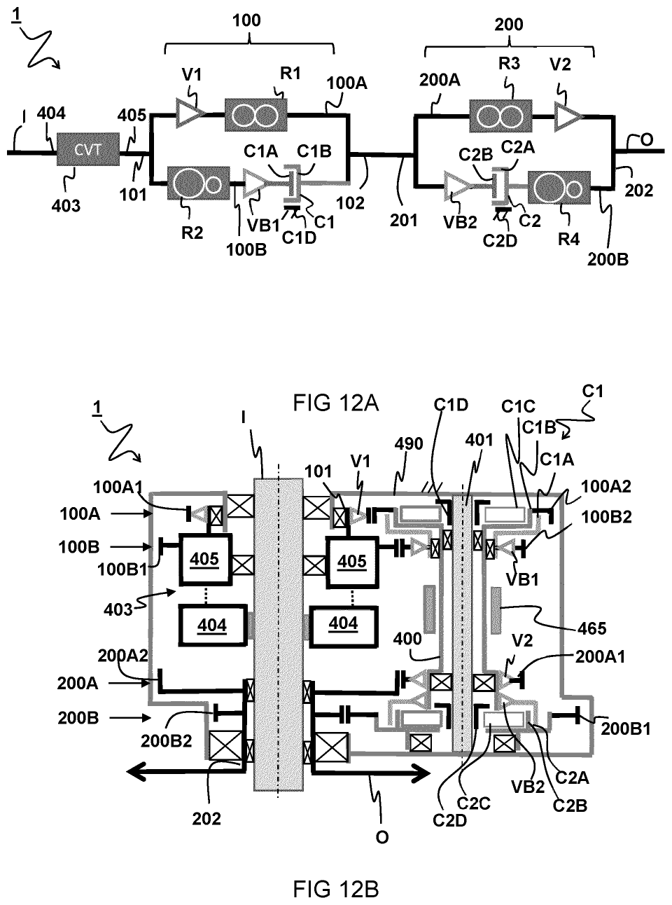

FIG. 12A shows another example of a transmission system 1 comprising a continuously variable transmission (CVT) 403 being connected in series with the first transmission 100 and the second transmission 200, similar to the example of FIG. 11A. In this example however, alternative to the example of FIG. 11A, the CVT 403 is arranged at an input side of the first transmission 100, such that the first transmission 100 is arranged between the CVT 403 and the second transmission 200. The first transmission 100 and the second transmission 200 as shown in FIG. 12A are similar to those shown in e.g. FIG. 11A. Also the CVT 403 may be similar as the CVT 403 shown in FIG. 4A, e.g. a ratcheting-type CVT.

FIG. 12B shows an exemplary schematic layout of the transmission system 1 as shown in FIG. 12A. In this example, alternative to the example shown in FIGS. 11A and 11B, the CVT input 404 is associated with, e.g. connected to, the system input I of the transmission system 1, in this example a rotatable input shaft. The input shaft I may for example be attached to a crank of a bicycle. Hence, the input shaft I may be a crank spindle. The transmission shown in FIG. 12B may thus, for example, be a crank transmission. The CVT output 405 is connected to the first input 101 of the first transmission 100. The CVT 403 is arranged to provide a continuously variable transmission ratio, e.g. a set of preprogrammed CVT transmission ratios, between the CVT input 404 and the CVT output 405. In this example, CVT input 404 is fixed to the input shaft, while the CVT output 405 is rotatable relative to the input shaft. The CVT output 405 is connected to the first input 101 of the first transmission 100, and is hereto provided with gear 100A1 for meshing gear 100A2 for forming the first transmission path 100A, and gear 100B1 for meshing with gear 100B2 for forming the second transmission path 100B.

The CVT 403 is in this example coaxially arranged with the input shaft I. The CVT is configured to apply a transmission ratio, e.g. a seventh and eighth transmission ratio between the CVT input 404, here being rotationally fixed to the input shaft I, and the CVT output 405. The first transmission 100 is formed in this example between the CVT output 405 and an intermediate shaft 400. The second transmission 200 is formed between the intermediate shaft 400 and the output shaft O. The intermediate shaft 400 is in this example rotatable relative to a stationary mounting shaft 401. The stationary mounting shaft 401 can for example be mounted to a housing of the transmission system.

In the example of FIG. 12B, the clutches C1 and C2 may for example be clutches as described in WO2018/199757A2, WO2020/085911A2, or WO2021/080431A1. Hence, the clutch C1 has a first rotatable unit CIA connected to the gear 100B1 at the clutch input, and a second rotatable unit C1B connected to the gear 100A2 at the clutch output. The first rotatable unit C1A includes at least one first abutment surface. The second rotatable unit C1B includes at least one second abutment surface arranged for selectively engaging the first abutment surface, the first and second abutment surfaces being adapted to each other so as to allow disengaging under load, preferably in two directions. The clutch C1 further has a third rotatable unit C1C. The third rotatable unit C1C includes at least one retaining member, the third unit C1C being arranged for selectively being in a first mode or a second mode relative to the second unit C1B, wherein the at least one retaining member in the first mode locks the at least one second abutment surface for rotationally coupling the second unit C1B to the first unit CIA, e.g. in two directions, and in the second mode releases the at least one second abutment surface for decoupling the second unit C1B from the first unit C1A. In this example, the clutch C1 comprises a third rotatable unit C1C which includes at least one actuation member arranged for moving the third rotatable unit C1C from a first position to a second position or from a second position to a first position relative to the second rotatable unit C1B. Here, the clutch C1 further comprises a fourth unit CID including a selector, the selector being arranged for selectively being in a gripping or non-gripping mode; the selector in the gripping mode being arranged for gripping the at least one actuation member for rotating the third rotatable unit C1C from the first position to the second position or from the second position to the first position relative to the second rotatable unit; the selector in the non-gripping mode being arranged for not engaging the at least one actuation member. Similarly, the clutch C2 includes a first rotatable unit C2A connected to the input, a second rotatable unit C2B connected to the output, and a third rotatable unit C2C arranged for co-rotating with the second rotatable unit. The third rotatable unit C2C is arranged for selectively being in a first rotational position or a second rotational position relative to the second rotatable unit. The clutch C2 is arranged for selectively in the first rotational position rotationally coupling the second rotatable unit C2B to the first rotatable unit C2A, and in the second rotational position decoupling the second rotatable unit C2B from the first rotatable unit C2A. The clutch C2 is arranged for temporarily changing rotation speed of the third rotatable unit C2C relative to the second rotatable unit C2A for rotating from the first position to the second position, or from the second position to the first position.

The example of FIG. 12A, 12B also includes an optional torque sensor 465. The torque sensor 465 is arranged to measure a torque transmission through the transmission system 1, specifically between the first transmission 100 and the second transmission 200, which is in this example transmitted by the intermediate shaft 400.

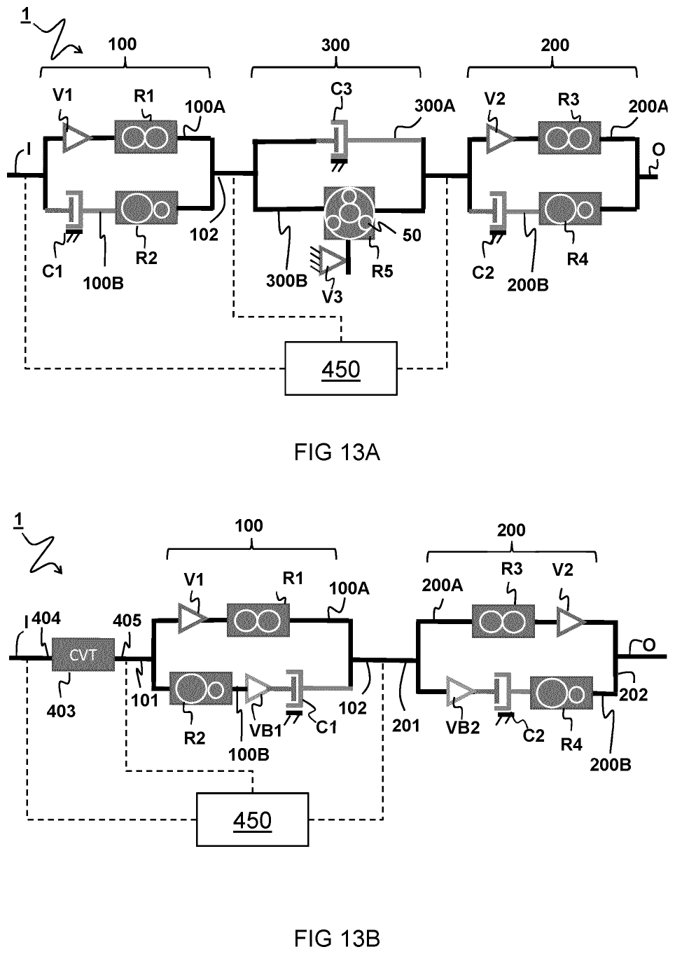

FIG. 13A shows an example of a transmission system 1, similar to the example as shown in FIGS. 9A-9C, wherein an electric motor 450 is connectable to an input of the first transmission 100, to an input of the second transmission 200, and/or to an input of the third transmission 300. FIG. 13B shows an example of a transmission system 1, similar to the example as shown in FIG. 12A-12B, wherein an electric motor 450 is connectable to the input 404 of the CVT 403, to the first input 101 of the first transmission 100, and/or to the second input 201 of the second transmission 200. The electric motor 450 can be used to propel, or at least assist in propelling, the vehicle. Hence, in this example, torque inputted by the electric motor 450 is transmitted through at least one transmission, e.g. for providing an appropriate transmission ratio between the electric motor 450 and the system output O.

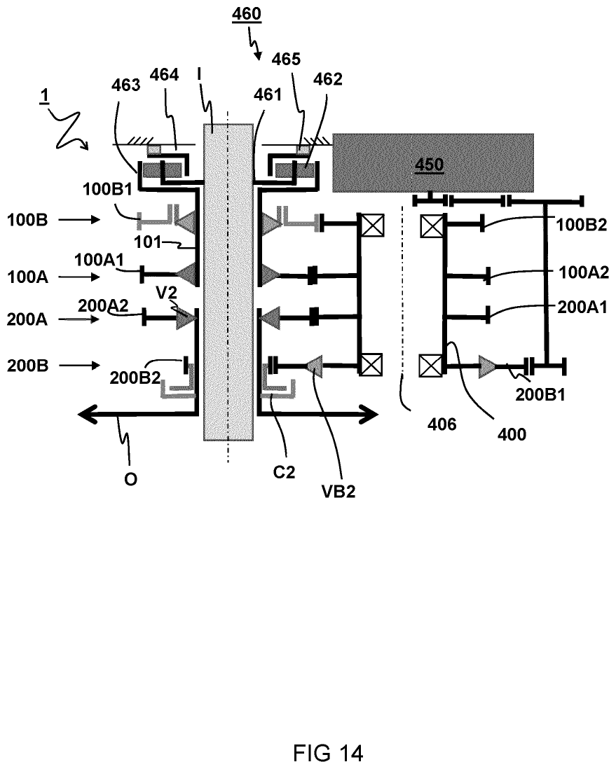

FIG. 14 shows an example of a transmission system 1, similar to the example of FIG. 4B, wherein an electric motor 450 is connected between the first transmission 100 and the second transmission 200, particularly to the second transmission path 200B of the second transmission 200. In this configuration, torque supplied by the electric motor 450 is not transmitted through the first transmission 100.

The transmissions system 1 in this example also comprises a speed-up gear 460 between the system input I and the input 101 of the first transmission 100. The speed-up gear 460 provides speed increase from the system input I and the first input 101. Here, the speed-up gear 460 comprises a planetary gear set comprising carrier 461 coupled to the input shaft, a planet gear 462 carried by the carrier 461 and a ring gear 463 coupled to the first input 101. The planet gear 462 meshes with the ring gear 463. A stationary sun gear 464 also meshes the planet gear 262, wherein the sun gear 464 is immobile, e.g. relative to a frame of the vehicle more specifically a frame of a bicycle. The sun gear 464, in this example, is connected to a torque sensor 465. The torque sensor 465 is arranged for measuring a torque at the system input I, e.g. a crank torque of a bicycle. Such stationary torque sensor 465 is particularly accurate compared to non-stationary torque sensors.

In particular for bicycles, but also for other vehicles, the input torque a the system input I may typically be high, at a relatively low speed. The speed-up gear 460 thus provides a speed increase as well as a torque reduction, between the system input I and the first input 101. This reduces loads on the transmission system 1, particularly on the first 100, second 200 (and any further) transmissions.

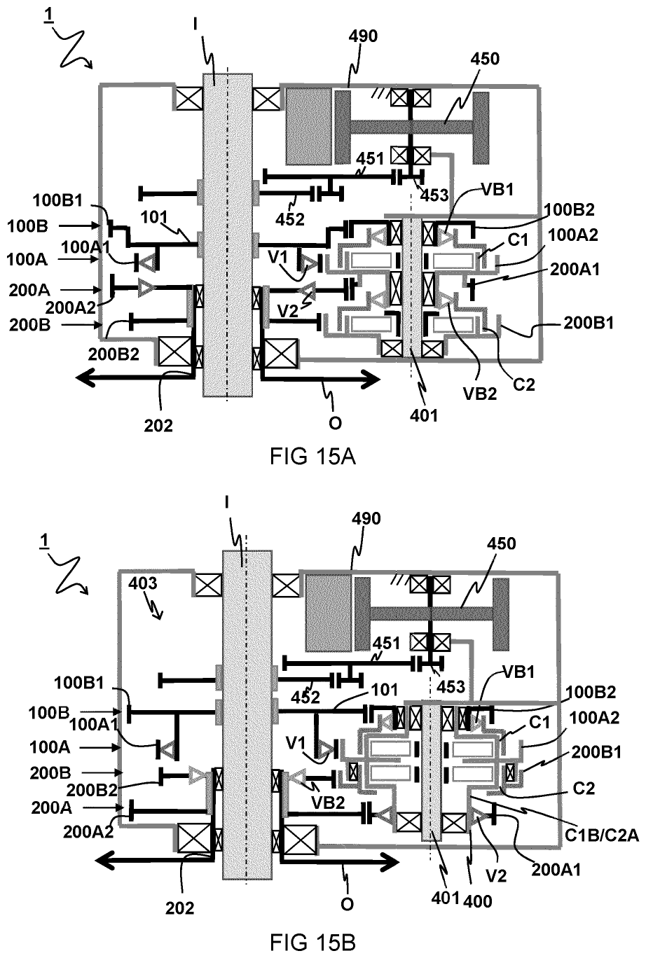

FIGS. 15A, 15B show respective examples of a transmission system 1. The example of FIG. 15A is similar to the example shown in FIGS. 5A, 5B, and the example of FIG. 15B is similar to the example shown in FIGS. 6A,6B. In the examples of FIGS. 15A, 15B, an electric motor 450 is connected to the first input 101 of the first transmission 100. The electric motor 450 is held by the housing 490, which housing 490 also holds the first and second transmissions 100, 200. The electric motor 490 is particularly coupled to the system input I, here an input shaft, in this case via a reduction gearing comprised of gear 452 mounted to the input shaft, gear 453 mounted to the electric motor output and stepped gear 451 meshing on one side with gear 452 and on another side with gear 453. Torque supplied by the electric motor 490 is transmitted through the first and second transmission 100, 200, to the system output O. The electric motor 450, here, comprises a stator 455 coupled to the housing 490, and a rotor 456 that is rotatably drivable relative to the stator 455. The electric motor 450 can accordingly be used to propel the vehicle, or at least assist in propelling the vehicle in conjunction with a user input at the system input I. It will be appreciated that the electric motor 450 can also be used as a generator, when driven by a user via the input shaft I. A clutch may be provided for selectively coupling and/or decoupling the electric motor 450 from the drive train.

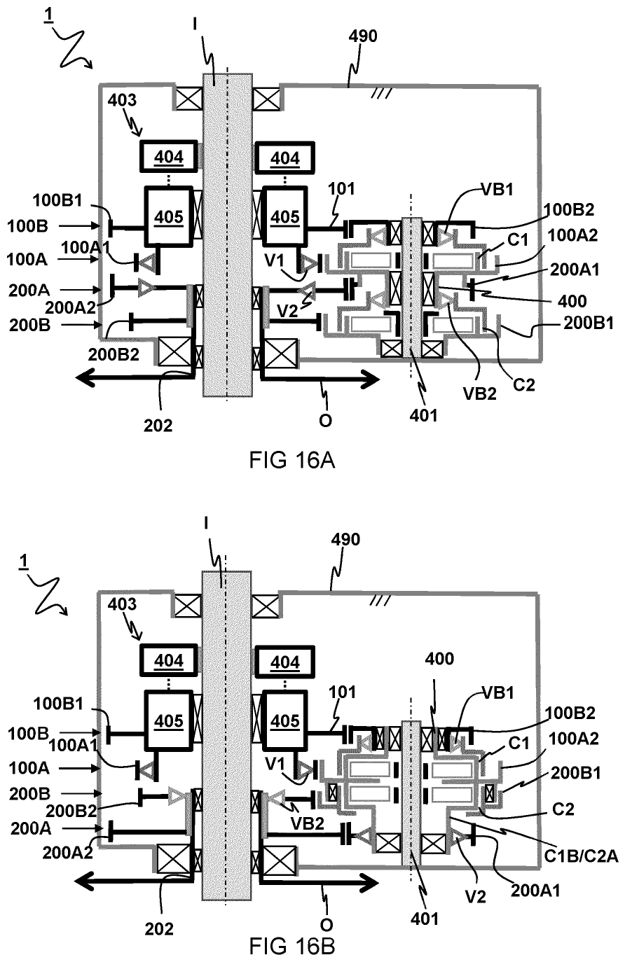

FIGS. 16A, 16B show respective examples of a transmission system 1 similar to the example shown in FIG. 15A, 15B respectively, but without the electric motor 450 and with a CVT 403. The CVT 403 is in these example arranged between the system input I and the first transmission 100, as is for example schematically shown in FIG. 12A. The CVT 403 is accommodated within the housing 490. The CVT input 404 is mounted to the input shaft I and rotates therewith. The CVT 403 applies a CVT transmission ratio between the CVT input 404 and the CVT output 405. The CVT transmission ratio is selectable from a continuous range of transmission ratios. The CVT 403 can for example be arranged to be operable according to a selective one of a finite set of preselected CVT transmission ratios within the continuous range of transmission ratios. A CVT actuator may be provided for actuating a transmission ratio change of the CVT. The CVT output 405 is rotatable about the input shaft I, relative to the input shaft I. The first input 101 of the first transmission 100 is associated with, or mounted to, the CVT output 405. Gears 100A1 and 100B1 of the first transmission 100 are in this example mounted to, or integrally formed with, the CVT output 405, for meshing with respectively gear 100A2 and gear 100B2, which are associated and rotatable about the mounting shaft 401, to form the first and second transmission ratios of the first transmission 100. Either the first transmission ratio or the second transmission ratio is selected using clutch C1. The second transmission 200 is formed between the mounting shaft 401 and the output shaft O. The third and fourth transmission ratios obtainable with the second transmission 200 are selectable using clutch C2.

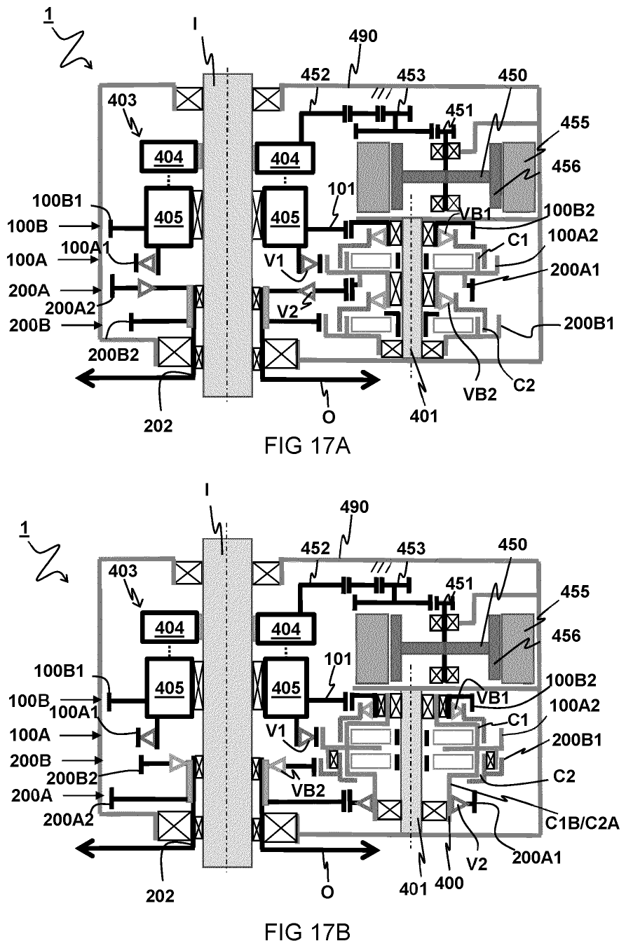

FIGS. 17A, 17B show respective examples of a transmission system similar to the examples shown in FIGS. 16A, 16B comprising both an electric motor 450 and a CVT 403. The electric motor 450 is in this example coupled, here via reduction gearing 451, 452, 453, to the CVT input 404. The CVT input 404 is in turn coupled to the input shaft I. Hence, the electric motor 450 drives the input shaft I in rotation, via the CVT input 404. The input shaft I can additionally be driven by an additional power source, such as by muscle power of a user transmitted to the input shaft I via a crank.

In the example of FIGS. 15A, 15B, 16A, 16B and 17A, 17B, the clutches C1 and C2 may for example be clutches as described in WO2018/199757A2, WO2020/085911A2, or WO2021/080431A1, as also set out in view of FIG. 11B.

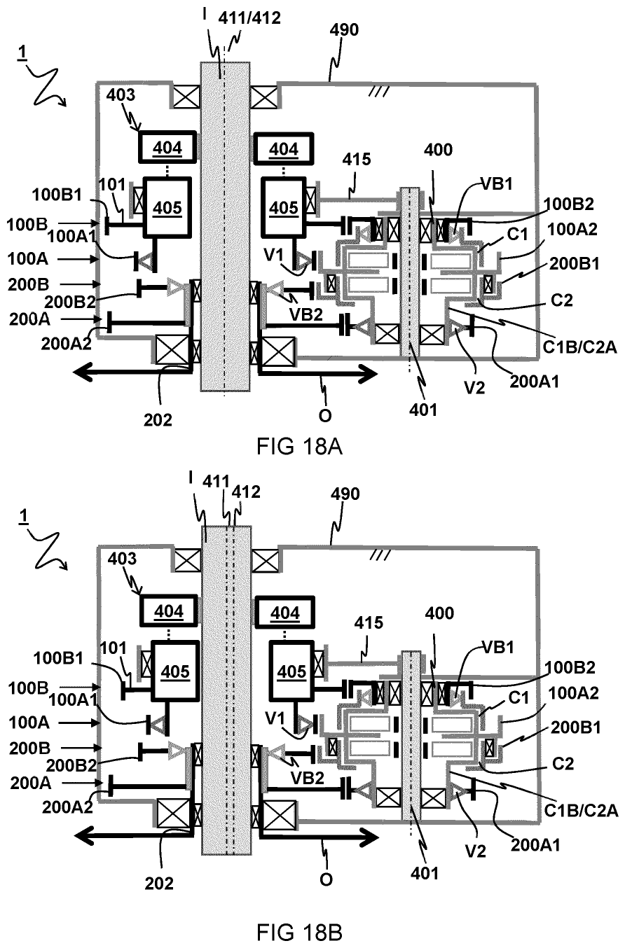

FIGS. 18A, 18B show an example of a transmission system 1, similar to the example shown in FIG. 16B. The CVT input 404 is rotatable about a CVT input axis 411. The CVT input is in this example mounted to the input shaft I, and is hence co-rotates with the input shaft I about the CVT input axis 411. The CVT output 405 is rotatable relative to the CVT input 405 about a CVT output axis 412.

In this example, the CVT output 405 is laterally movable relative to the CVT input 404, in a direction transverse to the CVT input axis 411. Various CVT transmission ratios can be obtained by laterally moving the CVT output 405 relative to the CVT input 404. The CVT input 404 and the CVT output 405 are in this example coupled by coupling elements, arranged for transferring torque from the CVT input 404 to the CVT output 405 at different radii. For example, the coupling elements may be provided at a constant first radius from the CVT input axis and at a variable second radius from the CVT output axis, wherein the second radius is variable by moving the CVT output 405 laterally relative to the CVT input 404, so as to offset the CVT output axis 412 from the CVT input axis 411. An example of such CVT is described in detail in co-pending patent application NL2028686.

FIG. 18A shows the transmission system 1 in a first state, in which the CVT input axis 411 and the CVT output axis 412 coincide. In the first state, the CVT 403 operates according to a 1:1 transmission ratio. FIG. 18B shows the transmission system 1 in a second, different state, in which the CVT output axis 412 is offset from the CVT input axis 411. The transmission system is transitioned from the first state to the second state by moving the CVT output 405 relative to the CVT input 404 in a direction transverse to the CVT input axis 411.

In this example, the CVT output 405 is pivotably drivable about a parallel axis; parallel to the CVT input axis 411. In this particular example, the CVT output 405 is pivotably coupled to the stationary mounting shaft 401, by a pivot arm 415. The pivot arm extends here between the mounting shaft 401 and the CVT output 405. The CVT output 405 is pivotably drivable at a constant radius from the mounting shaft 401; the constant radius being defined by the pivot arm 415. The primary gears 100A1 and 100B1 of the first transmission 100 are in this example mounted to the CVT output 405 and are hence also pivotable along with the CVT output 405 about the mounting shaft 401. Because the secondary gears 100A2 and 100B2 of the first transmission are rotatingly associated with the mounting shaft 401, the primary-secondary gear pairs 100A1-100A2 and 100B1-100B2 can remain meshingly engaged while the CVT output 405 is being pivoted about the mounting shaft 401.

A CVT shift actuator may be arranged for pivoting the pivot arm about the mounting shaft 401, in turn offsetting the CVT output 405 relative to the CVT input 404. The pivot arm 415 may for example be fixed to the mounting shaft 401, wherein the CVT shift actuator is arranged for rotating the mount shaft 401 about its longitudinal axis.

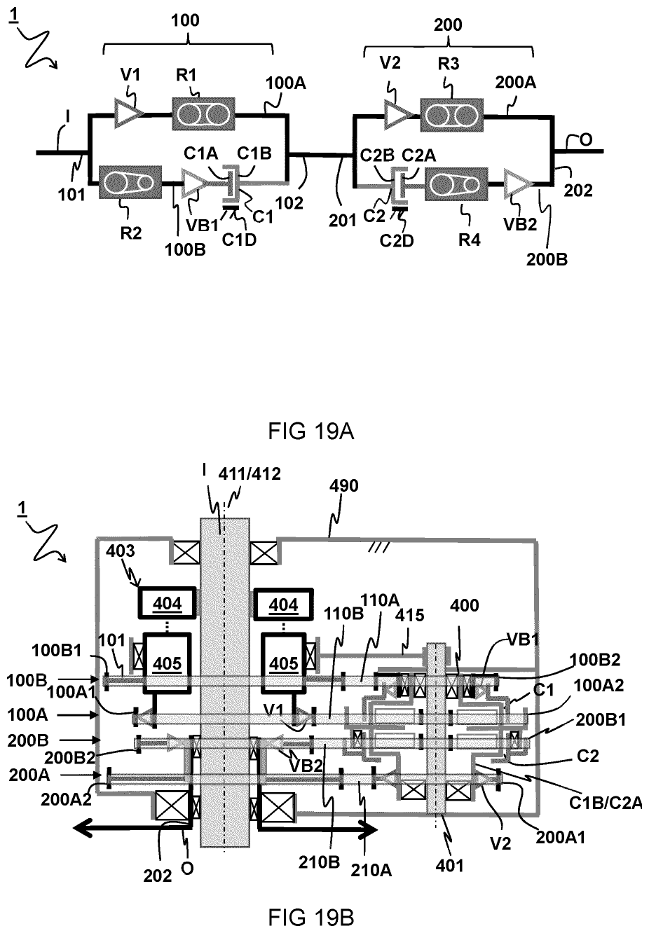

FIGS. 19A, 19B show an example of a gearless transmission system 1. The transmission system 1 in this example is similar to the example shown in FIGS. 18A, 18B, but instead of gear drives for the first and second transmissions 100, 200, the first and second transmissions includes belt drives for transmitting torque. In particular, the first transmission 100 comprises a first endless drive member 110A arranged in the first transmission path 100A, and a second endless drive member 110B arranged in the second transmission path 100B. The first and second endless drive members 110A, 110B, e.g. a first and second belt or chain, connect, respectively, a first and second primary wheel 100A1, 100B1, e.g. a primary chain wheel, with a first and second secondary wheel 100A2, 100B2, e.g. a secondary chain wheel.

In this example, the second transmission 200, similarly, comprises a third endless drive member 210A arranged in the third transmission path 200A, and a fourth endless drive member 210A arranged in the fourth transmission path 200B. The third and fourth endless drive members 210A, 210B, e.g. a third and fourth belt or chain, connect, respectively, a third and fourth primary wheel 200A1, 200B1, e.g. a primary chain wheel, with a third and fourth secondary wheel 200A2, 200B2, e.g. a secondary chain wheel. It will be appreciated that the any of the gear drives of the transmission systems described herein may also be configured as a belt drive.

The exemplary gearless transmission system 1, shown in FIGS. 19A, 19B, does not include meshing gears, and may accordingly be free of oil lubrication. No oil bath is present for lubricating rotational members of the transmission. Standard bearings, e.g. roller bearings, are used instead. There are in this example accordingly no need for oil seals to seal the housing 290. Instead of lubrication oil, a minimal amount of lubrication grease may be applied. The endless drive members and their associated wheels may even be completely free of lubrication.

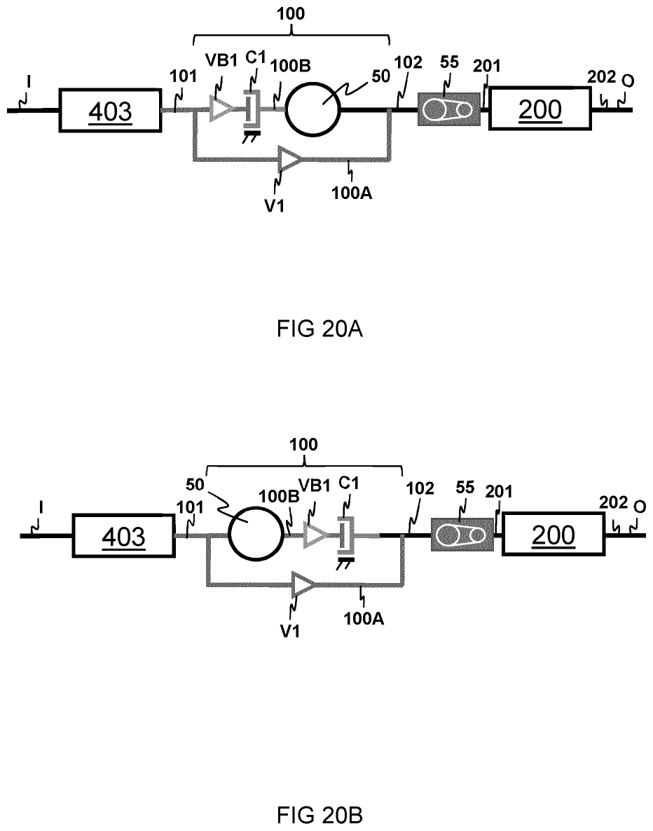

FIGS. 20A-20B show exemplary transmission systems 1, wherein the CVT 403 is connected at an input side of the first transmission 100, and wherein the first transmission 100 includes a planetary gear set 50. Here, the CVT 403 is connected in series to the first transmission 100. The planetary gear set is arranged in one of the transmission paths of the first transmission 100, here in the second transmission path 100B. The other transmission path, here the first transmission path 100A, in this example provides a 1:1 transmission ratio. The first transmission 100 is, here, connected to the second transmission 200 via an endless drive member 55, e.g. a chain, belt, or cardan drive. It will be appreciated that the second transmission 200 and the endless drive member 55 may be omitted. In the exemplary arrangement of FIGS. 20A, 20B, the CVT 403 and the first transmission 100 may be configured to be used as a crank transmission, e.g. between a crank and a front chain wheel of a bicycle, and the second transmission may be configured to be used as a hub transmission, e.g. between a rear sprocket and wheel hub of the bicycle. The endless drive member 55 may for example connect the front chain wheel and the rear sprocket, for transmitting torque from the front chain wheel to the rear sprocket.

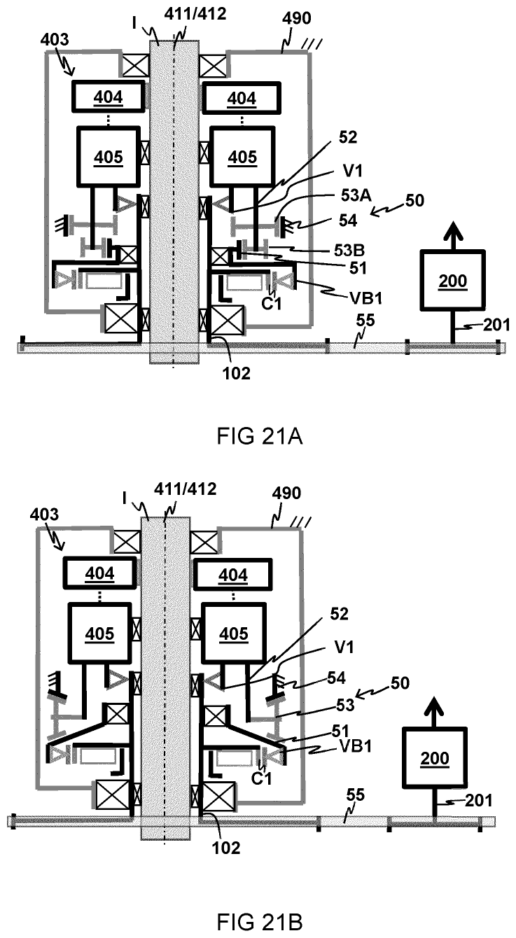

FIGS. 21A-21B show exemplary transmission systems 1, particularly in accordance with the example of FIG. 20B. The planetary gear set 50 is concentrically arranged with respect to the input shaft I. The planetary gear set 50 includes at least three rotary members: here a sun gear 51, a planet carrier 52 carrying one or more planet gears 53, and a ring gear 54. Here, the planet carrier 52 is fixed to the CVT output 405, and corotates therewith about the input axis 411. The planet carrier 52 carries in this example multiple planet gears 53 of which two are shown.

In the example of FIG. 20A, the planet gear rotation axes are parallel to the input axis 411, whereas in the example of FIG. 20B the planet gear rotation axes are arranged at an angle, particularly transverse, to the input axis 411.

The planet gears 53 in FIG. 20A are embodied as stepped planet gears. This way, a transmission ratio obtainable with the planetary gear can be increased, compared to arrangements with non-stepped planet gears. Hence, each planet gear 53 includes a large planet member 53A and a small planet member 53B being fixed to each other, and co-rotatable about a respective rotation axis. The large planet member 53A of the stepped planet gear engages the ring gear 54, whereas the small planet member 53B engages the sun gear 51.

The first transmission 100 is selectively operable according to two different transmission ratios R1, R2, wherein, here, R1=1.00 and R2=2.00. R2 is provided by the planetary gear set. With clutch C1, the first transmission 100 can switch between the first transmission path 100A and the second transmission path 100B. Clutch C1 can either be connected at an input of the planetary gear set, or at an output of the planetary gear set.

Torque is transmitted from the CVT input 404 to the CVT output 405. The planet carrier 52 is fixed to the CVT output 405 and corotates therewith about the input shaft I. From the planet carrier 52, torque is transmitted via the stepped planet gears 53 to the sun gear 51, which is couplable to the first transmission output 102 via clutch C1. If clutch C1 is decoupled, however, torque is not transmitted through the planetary gear set, but through the first transmission path 100A which bypasses the planetary gear set. Via the first transmission path 100A, torque is transmitted from CVT output 405 to the first transmission output 102 via freewheel clutch V1. The output 102 of the first transmission 100 may be connected to the input 201 of the second transmission 200, here via an endless drive member 55, e.g. a chain or belt. Other connections are also envisioned.

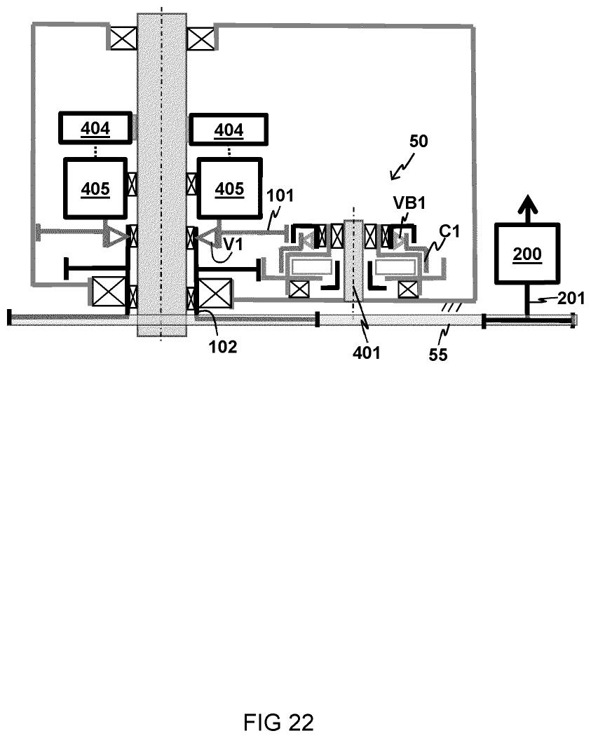

FIG. 22 shows an example of a transmission system 1, which may be an offset alternative configuration to the coaxial examples shown in FIGS. 21A-21B. Similar to the example of FIGS. 21A-21B, one transmission path of the first transmission 100 provides a 1:1 transmission ratio between the CVT output 405 and the first transmission output 102, and another transmission path provides a non-unity transmission ratio, here a transmission ratio of 2.00. Instead of a coaxially arranged planetary gear set 50 as shown in FIGS. 19A and 19B, the second transmission path 100B extends via an offset intermediate axis, here defined by a stationary mounting shaft 401. Compared to the coaxial arrangement shown in FIGS. 21A, 21B, the example of FIG. 22 is relatively compact in axial direction. On the other hand, the coaxial arrangement of FIGS. 21A-21B is relatively compact in radial direction, compared to the offset arrangement of FIG. 22.

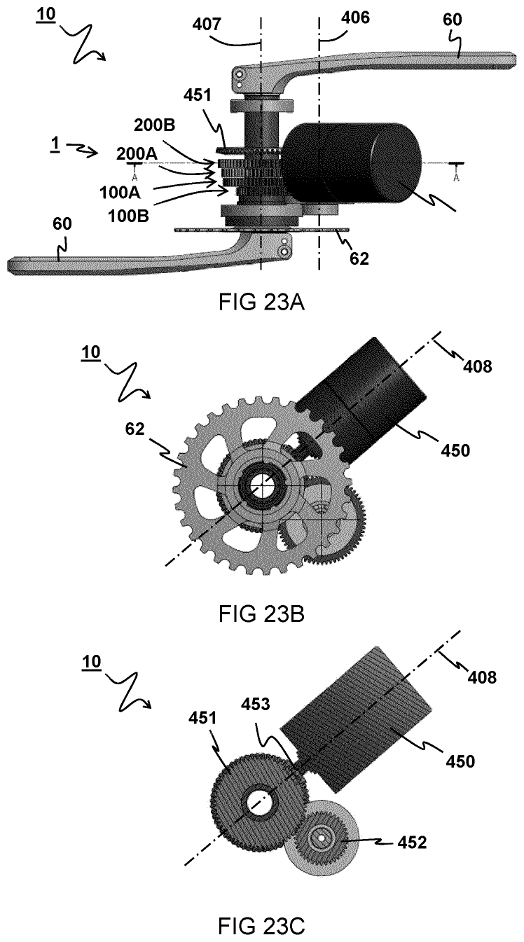

FIGS. 23A-23C show an exemplary implementation of a transmission system 1 as described herein as a crank transmission for a bicycle. The transmission system is similar to that as shown in FIG. 3. FIGS. 23A-23C show particularly a crank assembly 10, wherein the transmission system 1 is provided between a crank 60 of the bicycle and a (front) chain wheel 62. FIG. 23A shows a top view of the crank assembly 10. FIG. 23B shows a side view of the crank assembly 10. FIG. 23C shows a cross-sectional view of the crank assembly 10.

In this example, the crank 60 is connected to, or forms, the system input I and the front chain wheel is connected to, or forms, the system output O. The front chain wheel 62 can engage an endless drive member, e.g. a chain or belt. Hence, the transmission system 1 can selectively provide one of various transmission ratios between the crank 60 and the front chain wheel 62.

The crank 60 and the front chain wheel 62 are associated with respectively an input shaft and an output shaft, which are (coaxially) rotatable about a common crank axis 407. The crank 60 and the front chain wheel 62 are connected via an intermediate shaft 400, which can be rotatable about an intermediate axis 406 parallel offset to the crank axis 407.

An electric motor 450, here a brushless DC motor, is arranged for driving the front chain wheel 62 additionally or alternatively to the crank 62. The electric motor 450 can be connectable to any one of the input shaft, intermediate shaft, and output shaft. In this example, the electric motor 450 is connected to the input shaft, here via pinion 453. Here, separate gearing 451, 452 is provided between the electric motor 450 and the intermediate shaft, comprising gear 451 mounted on the input shaft, and gear 452 mounted on the intermediate shaft. Hence, the transmission system can provide different transmission ratios between the electric motor and the front chain wheel 62 and between the crank 60 and the front chain wheel 62. From the intermediate shaft torque inputted by the electric motor 450 is transmitted through a transmission path of the transmission system e.g. through a transmission path of the second transmission.

Here, an output axis 408 of the electric motor 450 extends transverse to the crank axis 407. The electric motor may be accommodated within a bicycle frame, for example in a seat tube or down tube of a bicycle frame. In this example, the output axis 408 extends radially with respect to the crank axis 407, in a direction that corresponds to a direction in which the downtube of a bicycle extends. The electric motor 450 in this example particularly has a cylindrically shaped housing for being accommodated in the down tube. The intermediate shaft is angularly spaced from the electric motor 450 to provide a compact setup. For a crank transmission for a bicycle, an example of suitable transmission ratios of the first, second, third and fourth gearings R1, R2, R3, R4, and the obtainable resultant system transmission ratios from the crank 60 to the front chain wheel 62 is given in table 20.

TABLE 20

| | C1 | C2 | System transmission ratio |
|---|---|---|---|
| R1 = 0.94 | Decoupled | Decoupled | 0.61 (R1*R3) |
| R2 = 1.37 | Coupled | Decoupled | 0.89 (R2*R3) |
| R3 = 0.66 | Decoupled | Coupled | 1.30 (R1*R4) |
| R4 = 1.38 | Coupled | Coupled | 1.90 (R2*R4) |

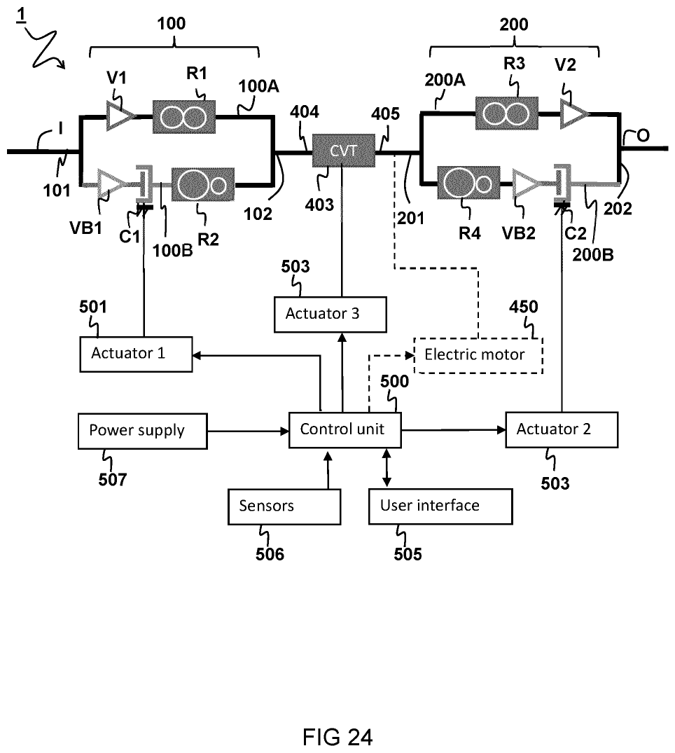

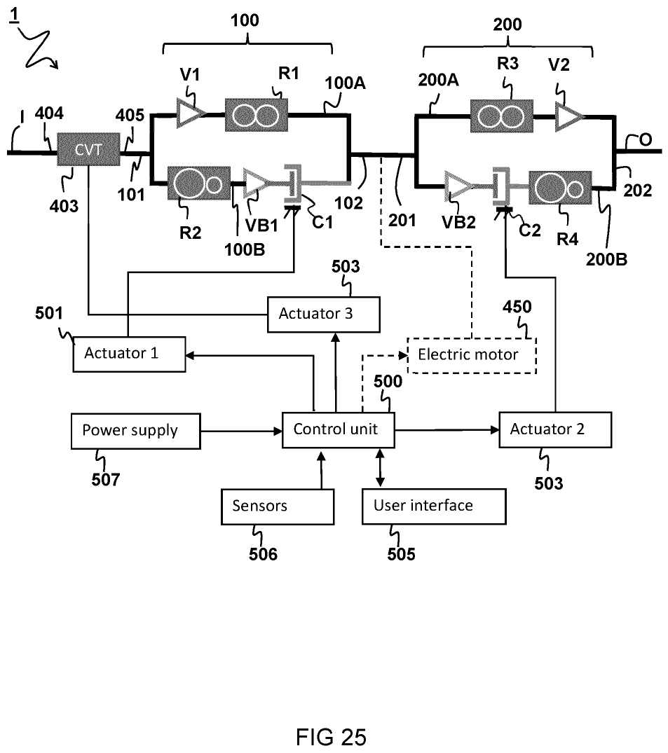

FIG. 24 shows a transmission system 1, similar to that as shown in FIG. 11A. FIG. 25 shows a transmission system, similar to that as shown in FIG. 12A. Here, the transmission systems 1, as shown in FIGS. 24 and 25, includes a control unit 500. It will be appreciated that each of the examples described herein may include a control unit 500 configured to receive a first shift signal and a second shift signal, and configured to control the first load-shifting clutch and/or the second load-shifting clutch and/or the third load-shifting clutch for selectively coupling or decoupling in response to receiving the first and/or second shift signal. The shift signal may for example be sent, e.g. wirelessly, from a user interface 505, such as from a manual shifter device, e.g. at a handlebar of the bicycle, and/or one or more sensors 506, such as a torque sensor, speed sensor, cadence sensor and/or heart-rate monitor.

The first shift signal can be an upshift signal and the second shift signal can be a downshift signal. The control unit 500 can be configured to selectively control the first and/or second and/or third load-shifting clutch (and optionally the CVT) for selecting the next higher system transmission ratio in response to receiving the upshift signal, and for selecting the next lower system transmission ratio in response to receiving the downshift signal. The controller can also be configured to selectively control the first and/or second and/or third load-shifting clutch for selecting the second next, third next, fourth next, fifth next, sixth next, seventh next, eighth next higher or lower system transmission ratio in response to receiving a bail-out signal. The bail-out signal may for instance include the upshift signal and downshift signal at the same time, or within a specified time-interval.

The control unit 500 can thus be connected, e.g. wirelessly, to a first actuator 501 for actuating the first, e.g. load-shifting, clutch C1 and to a second actuator 502, e.g. wirelessly, for actuating the second, e.g. load-shifting, clutch C2. The control unit 500 can also be connected, e.g. wirelessly, to a third actuator 503 for actuating the CVT 403. The CVT 403 may be operable according to various transmission ratios. Each of the CVT transmission ratios may preprogrammed, and adapted to the transmission ratios of the first and second transmissions, 100, 200. A power supply 507 may supply power, e.g. electric power, to the control unit 500 and the actuators 501, 502, 503, sensors 506, and/or the user interface 505. The power supply may for example comprise a battery. The control unit 500 may also be arranged to operate the electric motor 450. The control unit 500 may be configured to regulate an output power or output torque of the electric motor 450. The control unit 500 may also be configured to operate a clutch for coupling and decoupling the electric motor 450 from transmission system. The electric motor 450 may be powered from a separate power source. The control unit 500 may for example include a look-up table to synchronize actuation of the one or more actuators in response to a shift signal.

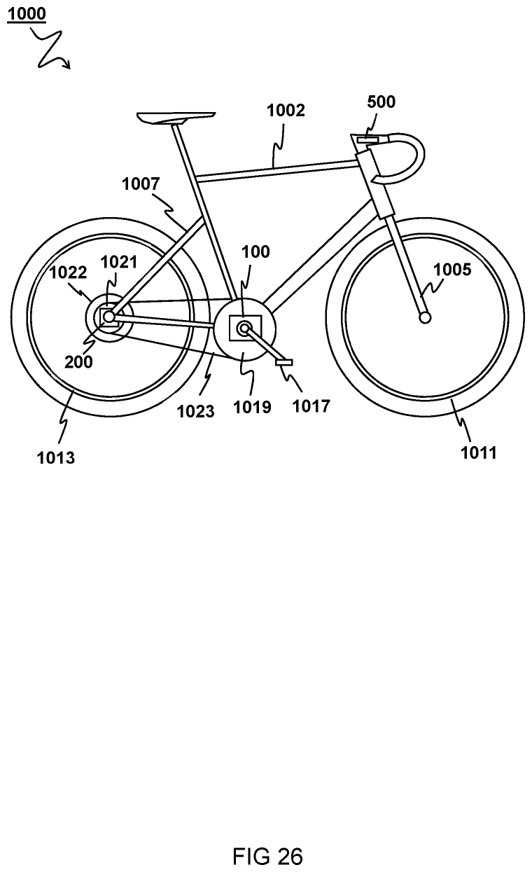

FIG. 26 shows a bicycle 1000. The bicycle 1000 comprises a frame 1002 with a front fork 1005 and a rear fork 1007, as well as a front wheel and a rear wheel 1011, 1013 located in the front and rear fork respectively. The bicycle 1000 further comprises a crank 1017, and a front chain wheel 1019. In this example, the first transmission 100 is interconnected between the crank 1017 and front chain wheel 1019. The bicycle 1000 also comprises a rear sprocket 1021 and a rear wheel hub 1022 of the rear wheel 1013, wherein a chain 1023 threads over the front chain wheel 1019 and rear sprocket 1021. In this example, the second transmission 200 is interconnected between the rear sprocket 1021 and the rear wheel hub 1022. A CVT 403 may be arranged between the crank 1017 and the front chain wheel 1019, particularly between the crank 1017 and the first transmission 100, e.g. as shown in FIGS. 20A,20B, 21A, 21B and 22. The bicycle 1000 also comprises a control unit 500, here connected to handlebars 1031. Here, the bicycle 1000 does not comprise a front and rear derailleur.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A transmission system for a human powered vehicle, such as bicycle, comprising
an input and an output, wherein the input is arranged to be connected to a power source, and the output is arranged to be connected to a load,
a first transmission and a second transmission between the input and the output, wherein the first transmission and the second transmission are connected in series,
the first transmission being selectively operable according to a first transmission ratio or a second transmission ratio, and having a first clutch for switching the first transmission from the first transmission ratio to the second transmission ratio and/or vice versa; and
the second transmission being selectively operable according to a third transmission ratio or a fourth transmission ratio, and having a second clutch for switching the second transmission from the third transmission ratio to the fourth transmission ratio and/or vice versa.

2.-3. (canceled)

4. The system of claim 1, wherein the first transmission includes a first transmission path for providing the first transmission ratio and a second transmission path, parallel to the first transmission path, for providing the second transmission ratio, at least one of the first and second transmission paths including the first clutch, wherein the second transmission includes a third transmission path for providing the third transmission ratio and a fourth transmission path, parallel to the third transmission path, for providing the fourth transmission ratio, at least one of the third and fourth transmission paths including the second clutch.

5.-13. (canceled)

14. The system of claim 1, wherein at least one of the first transmission and the second transmission includes a planetary gear set.

15. (canceled)

16. The system of claim 1, wherein at least one of the first transmission ratio, the second transmission ratio, the third transmission ratio and the fourth transmission ratio is a 1:1 transmission ratio.

17.-18. (canceled)

19. The system of claim 1, wherein when a ratio of the second transmission ratio and the first transmission ratio is equal to U, a ratio of the fourth transmission ratio and the third transmission ratio is equal to U².

20.-21. (canceled)

22. The system of claim 1, wherein a ratio of the second transmission ratio and the first transmission ratio is between 1.1 and 1.3.

23.-28. (canceled)

29. The system of claim 1, further comprising a third transmission connected in series with the first and second transmissions between the input and the output, the third transmission having a third clutch, and the third transmission being operable according to a fifth transmission ratio and a sixth transmission ratio.

30. The system of claim 29, wherein when a ratio of the second transmission ratio and the first transmission ratio is equal to U, a ratio of the sixth transmission ratio and the fifth transmission ratio is equal to U⁴.

31. (canceled)

32. The system of claim 1, further comprising a bypass transmission path between the input and the output parallel to the first and/or second and/or third transmission, said bypass transmission path including a bypass clutch.

33. The system of claim 1, further comprising an intermediate shaft, and wherein the first transmission is operable between the input and the intermediate shaft, and the second transmission is operable between the intermediate shaft and the output.

34.-37. (canceled)

38. The system of claim 1, wherein each of the clutches are load-shifting clutches arranged for being coupled and/or decoupled under load.

39. The system of claim 38, wherein each load-shifting clutch has a clutch input, and a clutch output, each load-shifting clutch including:
a first unit connectable to the clutch input or clutch output, including at least one first abutment surface;
a second unit connectable to the clutch output or clutch input, respectively, including at least one second abutment surface arranged for selectively engaging the first abutment surface, the first and second abutment surfaces being adapted to each other so as to allow disengaging under load;
a third unit including at least one retaining member, the third unit being arranged for selectively being in a first mode or a second mode relative to the second unit, wherein the at least one retaining member in the first mode locks the at least one second abutment surface for rotationally coupling the second unit to the first unit, and in the second mode releases the at least one second abutment surface for decoupling the second unit from the first unit.

40.-57. (canceled)

58. The system of claim 1, further comprising an electric motor, for propelling, or assist propelling, of the vehicle, wherein the electric motor is connected to the input, to the output, or to an intermediate member.

59.-60. (canceled)

61. The system of claim 1, further comprising a continuously variable transmission arranged between a system input and the first transmission or between the first transmission and the second transmission or between the second transmission and a system output.

62. (canceled)

63. A crank assembly for a bicycle, comprising a crank coupled to an input shaft and a chain wheel coupled to an output shaft for meshing with an endless drive member, and a transmission system of claim 1, wherein the transmission system is arranged between the crank and the chain wheel.

64. The crank assembly of claim 63, wherein input shaft and the output shaft are rotatable around a common drive axis, and wherein the crank assembly comprises an electric motor connected to the input shaft or the output shaft, wherein the electric motor has a rotatable output member that is rotatable about an electric motor output axis which extends transverse to the drive axis.

65. (canceled)

66. A bicycle comprising a transmission system of claim 1.

67. The bicycle of claim 66, comprising a torque transfer system having a torque transfer member, wherein a crank drives an input of the torque transfer system, and wherein an output of the torque transfer system drives a driven wheel of the bicycle, wherein a) the transmission system is arranged between the crank and the input of the torque transfer system, or b) the transmission system is arranged between the output of the torque transfer system and a wheel hub of the driven wheel, or c) the first transmission of the transmission system is arranged between the crank and the input of the torque transfer system, and wherein the second transmission of the transmission system is arranged between the output of the torque transfer system and a wheel hub of the driven wheel.

68.-69. (canceled)

70. The bicycle of claim 66 further comprising a third transmission connected in series with the first and second transmissions between the input and the output, the third transmission having a third clutch, and the third transmission being operable according to a fifth transmission ratio and a sixth transmission ratio, and further comprising a torque transfer system having a torque transfer member, such as a chain or belt or shaft wherein a crank drives an input of the torque transfer system, and wherein an output of the torque transfer system drives a driven wheel of the bicycle, wherein the first and second transmission of the transmission system are arranged between the crank and the input of the torque transfer system, and wherein the third transmission of the transmission system is arranged between the output of the torque transfer system and a wheel hub of the driven wheel.

71.-72. (canceled)

73. A gearless transmission unit providing at least two discrete selectable transmission ratios, wherein a first of the at least two transmission ratios is provided by a first endless drive member, and wherein a second of the at least two transmission ratios is provided by a second endless drive member, wherein the first and second endless drive members are placed in parallel between an input and an output of the gearless transmission unit, and the gearless transmission unit includes a selector for selecting power transmission via the first or the second endless drive member.

74.-85. (canceled)
